(19) United States
(12) Patent Application Publication
(10) Pub. No.: US 2025/0051541 A1
(43) Pub. Date: Feb. 13, 2025

(54) Molecular Weaving Additives to Enhance the Mechanical Properties of Materials

(71) Applicant: The Regents of the University of California, Oakland, CA (US)

(72) Inventors: Sebastian Ephraim Neumann, Berkeley, CA (US); Junpyo Kwon, Berkeley, CA (US); Cornelius I.R. Gropp, Berkeley, CA (US); Ting Xu, Berkeley, CA (US); Omar M. Yaghi, Berkeley, CA (US)

(73) Assignee: The Regents of the University of California, Oakland, CA (US)

(21) Appl. No.: 18/895,391

(22) Filed: Sep. 25, 2024

Related U.S. Application Data
(63) Continuation of application No. PCT/US2023/016175, filed on Mar. 24, 2023.
(60) Provisional application No. 63/326,892, filed on Apr. 3, 2022.

(51) Int. Cl. C08K 5/00; C08J 3/215

(52) U.S. Cl. CPC C08K 5/0091; C08J 3/215; C08J 2333/12; C08J 2379/08; C08K 2201/005; C08K 2201/011

(57) ABSTRACT

Methods and compositions wherein crystalline woven and interlocked covalent organic frameworks (COFs) are used as additives to achieve combinations of high toughness and elasticity in polymers.

### CROSS-REFERENCES TO RELATED APPLICATIONS

This application is a continuation of PCT/US23/16175, filed Mar. 24, 2023, which claims priority to U.S. Provisional Application No. 63/326,892, filed Apr. 3, 2022, the disclosures of which are hereby incorporated by reference in its entirety for all purposes.

### GOVERNMENT SUPPORT CLAUSE

This invention was made with government support under grant number HR0011-20-2-0038 from the Department of Defense Advanced Research Projects Agency. The government has certain rights in the invention.

### INTRODUCTION

Mechanically robust polymers with enhanced longevity and reliability are particularly attractive as next generation materials for the realization of a sustainable society. Weaving of threads is one of the most enduring methods to enhance the durability and material strength of fabrics, while ensuring a high degree of flexibility and processability. Despite its ubiquitous presence in the macroscopic world, it is largely unknown on a molecular level. Chemically cross-linking and entanglements of single stranded polymers are currently state-of-the art to enhance the durability and material strength of fabrics on a molecular level. The incorporation of nanoscopic particles into polymers enables the design of specialized nanocomposites that exhibit enhanced mechanical properties. The complex nature of filler-polymer interactions, however, makes it hard to predict the influence a specific filler material will have on the mechanical properties, often resulting in increased stiffness at the cost of the nanocomposite's toughness.¹⁻³

### SUMMARY OF THE INVENTION

The invention provides methods and compositions wherein crystalline woven and interlocked covalent organic frameworks (COFs) are used as additives to achieve combinations of high toughness and elasticity in polymers. By implementing these mechanically-bonded moieties into the polymer matrices, the mechanical properties such as toughness and elasticity can be enhanced. This invention enables the use of new filler materials that can be applied to a wide range of commercially available polymers to enhance their mechanical properties by introducing weaving on a molecular level.

The co-polymerization of woven covalent organic framework (COF) additives with conventional polymers, such as polyimide, enhances the overall mechanical properties of conventional polyimides. Woven and crystalline COF/polymer composites may be used to enhance the mechanical properties of a wide variety of commercially available polymer materials, including but not limited to polyimides, polyesters, polyamides, and polyamines.

In aspects the invention provides:
1. A composition comprising crystalline woven and interlocked covalent organic frameworks (COFs) mechanically-bonded into matrices of a polymer, wherein a mechanical property of the polymer such as toughness or elasticity is enhanced.
2. A method to enhance a mechanical property of a polymer such as toughness or elasticity, comprising using crystalline woven and interlocked covalent organic frameworks (COFs) as an additive to the polymer, wherein by implementing these mechanically-bonded moieties into the polymer matrices, the mechanical property is enhanced.
3. A composition comprising co-polymerized woven and crystalline covalent organic framework (COF) additives with a polymer, wherein the copolymerization enhances a mechanical property of the polymer.
4. A method comprising co-polymerizating woven and crystalline covalent organic framework (COF) additives with a polymer, wherein the copolymerization enhances a mechanical property of the polymer.
5. A composite composition comprising woven and interlocked covalent organic frameworks (COFs) and their interface with a polymer.
6. A method of synthesis comprising forming a composite composition comprising woven and interlocked covalent organic frameworks (COFs) and their interface with a polymer.
7. A composite material composition comprising woven covalent organic frameworks (COFs), wherein atomically defined organic threads linked though chemically stable amide functionalities are mechanically interlocked and woven.
8. A method of making a composite material comprising woven covalent organic frameworks (COFs), wherein atomically defined organic threads linked though chemically stable amide functionalities are mechanically interlocked and woven, comprising forming the composite material.

Embodiments include:
comprising post-synthetic modification of woven and interlocked imine-based COFs by oxidation, thereby introducing chemically irreversible amide-linkages.
the crystalline woven and interlocked COFs are amide-linked.
the crystalline woven and interlocked COFs are co-polymerized in the form of particles, preferably in sizes of about 50-500 nm, or 100-300 nm, or about 200 nm.
adding from about 0.1, 0.2 or 0.5 to about 5 weight percent (wt %) of woven or interlocked crystallites.
the composition comprises homogenous distribution of woven or interlocked crystallites within the polymer, with no phase separation.
providing an increase in elastic modulus and toughness of the COF-polymeer composites by more than 30%.
the polymer is selected from a polyimide, polyester, polyamide, and polyamine, preferably polyimide.
the polymer monomers are 4,4′-oxydipehnylamine and pyromellitic dianhydride to form poly (4,4′-oxydipehnylene-pyromellitimide) polymer.
adding COF nanocrystals (0.5-5% wt %) into liquid crystalline and/or amorphous polymers, (e.g. polyimide (PI) and polymethyl methacrylate (PMMA)).
polymer-COF junctions are generated by using a COF nanocrystal in which the framework itself is constructed from woven threads that lead to in-situ formation of high-aspect ratio nanofibers.
the COF filler comprises covalently linked organic building units that form one-dimensional organic threads, which are interlaced to generate a 3D woven structure in the form of crystals hundreds of nanometers in size.
the COF nanocrystals comprise multiple repeating unit cells that generate a porous environment mimicing the polymer matrix in its chemical structure, facilitating polymer/COF interactions.
each unit cell has dimensions comparable to the tube diameter of the polymer reptation, allowing the polymer chains to thread through the framework.
the woven COF nanocrystals are penetrated by polymer chains, thereby chemically decorating the surface, which enhances the chemical compatibility with the matrix polymer.
the dangling polymer chains on the surface of the COF nanocrystals form interfaces to bridge between the interwoven polymer chains and the matrix to form polymer-COF junctions.

The invention encompasses all combinations of the particular embodiments recited herein, as if each combination had been laboriously recited.

### BRIEF DESCRIPTION OF THE DRAWINGS

FIG. 1A-B. FT-IR studies investigating the oxidative linkage conversion. (a) Comparing FT-IR spectra of COF-500 (imine) and COF-501 (amide) in a range from 1500 cm 1 to 1700 cm 1. (b) Comparing FT-IR spectra of COF-506 (imine) and COF-507 (amide) in a range from 1500 cm 1 to 1700 cm 1.

FIG. 2A-B. Solid-state NMR studies investigating the oxidative linkage conversion. (a) Comparison of CP-MAS NMR spectra of ¹³C-labeled Cu-COF-500 and ¹³C-labeled Cu-COF-501 indicates the disappearance of the signal related to the imine functionality and the emergence of an amide-related signal at a higher chemical shift. (b) Comparison of CP-MAS NMR spectra of ¹³C-labeled Cu-COF-506 and ¹³C-labeled Cu-COF-507 indicates the disappearance of the signal related to the imine functionality and the emergence of an amide-related signal at a higher chemical shift.

FIG. 3. SEM micrographs taken before and after the oxidation process. The micrographs of (a) the interlocked Cu-COF-500 and (b) Cu-COF-501 show that the crystal size, shape, and morphology are conserved throughout the oxidation from imine to amide linkage. The micrographs of (c) the interlocked Cu-COF-506 and (d) Cu-COF-507 show that the crystal size, shape, and morphology remain intact throughout the oxidation from imine to amide linkage.

FIG. 4. Nanoindentation studies investigating the impact of the presence of metal ions within the weaving nodes on the mechanical behavior of amide-linked woven and interlocked COFs: Load-Depth Curve measured by nanoindentation.

FIG. 5. Generalized process for the synthesis of COF/polymer composites.

FIG. 6A-B. AFM micrographs of polyimide and COF-polyimide composites. (a) The AFM micrograph of polyimide shows an even polymer film with no signs of disturbances or impurities. (b) The AFM micrograph of the COF-polyimide composite including the woven Cu-COF-507 indicates a homogenous distribution of COF particles within the polymer matrix. No agglomeration or clumping of COF particles is observed.

FIG. 7. Stress-strain curves for different COF-polyimide composites compared to pure polyimide. The comparison of the mechanical behavior of polyimide films to COF-polyimide composites shows an increase in elastic modulus and toughness for woven and interlocked metellated COF fillers. The use of demetallated woven and interlocked COFs as fillers lead to a slight increase in elastic modulus, whereas the use of the commonly known COF-300 decreases the clastic modulus of the final material.

FIG. 8A-C. Representation of (A) simple biaxial weaves, (B) chain links, and (C) triaxial weaves.

FIG. 9. Representation of 2-periodic links and knots.

FIG. 10. Representation of 3-periodic fabric weaving.

FIG. 11. Representation of 3-periodic chain-link weaving with parallel threads.

FIG. 12. Representation of 3-periodic chain-link weaving with non-parallel threads.

FIG. 13. Representation of 3-periodic polycatenanes (interlocked systems).

FIG. 14. Representation of thread plus ring weavings.

FIG. 15A-C. Schematic illustration of the COF structure, polymers, and nanofibrils. (A) In situ formation of polymer-COF junctions. Individual polymer chains penetrate the porous, 3D woven COF crystals and decorate the surface to interact with the polymer matrix. (B) The COF nanocrystals are distributed nanoscopically without any necessary surface modification to enhance compatibility. (C) Polymer-COF composites under stress. The polymer chains align spatially and unthread from the COF crystals, thereby generating a favorable pathway for energy dissipation and forming nanofibrils.

FIG. 16A-G. PMMA-COF composites characterization. (A) TEM image of PMMA-MW (3 wt. %) shows well-dispersed MW nanocrystals in the PMMA matrix. (B) WAXS spectra of MW, PMMA, and PMMA-MW. The deconvoluted characteristic peak of MW in the PMMA matrix shows a slight shift to a lower q-vector, indicating an expansion of the MW's unit cell within the composite. (C) WAXS spectra of MI, PMMA, and PMMA-MI showing no change in the MI unit cells in the composite. (D) DSC curves of PMMA and PMMA-MW reveal an increase in T_{g} (˜10° C.). (E) GPC traces of PMMA and PMMA-MW show a decrease in PMMA molecular weight after PMMA-MW junction removal. (F) Engineering stress-strain curves of PMMA-MW compared to pure PMMA. (G) SEM images of the fracture surfaces of PMMA-MW from the double-notch experiment. Cracks in the PMMA-MW contain high-aspect-ratio nanofibrils (λ˜5).

FIG. 17A-J. PI-COF composites. (A) WAXS studies comparing MW and PI-MW composites show a slight peak shift to lower q-vectors. (B) WAXS studies comparing MI and PI-MI composites. (C) PI-MW (3 wt. %) shows increased damage tolerance in the presence of defects when the strain reaches ˜0.94 mm/mm. (D) An SEM image of PI-MW (3 wt. %) across hundreds of micrometer length scales. (E) SEM images of fracture surfaces of the PI-MW showing high-aspect-ratio fibers. (F) EDS line scan of nanofibrils shows a transition in the chemical composition from PI-MW composite to pure PI. Engineering stress-strain curves of (G) PI-MW and (H) PI-MI composites compared to pure PI. Comparison of stress and toughness in (I) PI-MW and (J) PI-MI composites as functions of filler concentration (n=5 samples for each condition).

FIG. 18A-D. Enhancement in damage tolerance of PI-MW compared to PI-MI. Double-notch experiments using (A) PI-MW and (B) PI-MI. Zoom-in SEM image displays in situ formation of multiple nanofibrils (λ˜16) bridging the separate MW crystals under stress. PI-MI displays lower aspect-ratio nanofibrils (λ˜5) with snapped-back tip-ends. The schematics to compare different molecular interactions of polymer chains and COFs, (C) MI and (D) MW.

FIG. 19. Synthesis of woven Cu-COF-506 and interlocked Cu-COF-500.

FIG. 20. Synthesis of amide-linked Cu-COF-501 (MI) and Cu-COF-507 (MW) (linkage conversion).

FIG. 21. Comparison of PXRD patterns of woven imine-linked (Cu-COF-506), amide-linked (Cu-COF-507, MW), and demetalated (COF-507, DMW) COFs. The PXRD patterns of the imine-linked and amide-linked woven COFs can be matched to the simulated pattern. After demetallation, the crystallinity is drastically reduced.

FIG. 22. Comparison of PXRD patterns of interlocked imine-linked (Cu-COF-500), amide-linked (Cu-COF-501, MI), and demetalated (COF-501, DMI) COFs. The PXRD patterns of the imine-linked and amide-linked interlocked COFs can be matched to the simulated pattern. After demetallation, the crystallinity is drastically reduced.

FIG. 23. PXRD spectrum of COF-300 compared to the simulated pattern for 7-fold interpenetrated COF-300.

FIG. 24. PXRD spectrum of COF-791 compared to the simulated pattern for COF-791.

FIG. 25. PXRD spectrum of MOF-808 compared to the simulated pattern for MOF-808.

FIG. 26. PXRD spectrum of MIL-53(Al) compared to the simulated patterns for the large and narrow pore models of MIL-53(Al).

FIG. 27. FTIR spectrum of interlocked Cu-COF-500 highlighting the imine bond stretch at 1622 cm⁻¹. The formation of imine bonds is confirmed by the presence of a characteristic imine bond stretch at 1622 cm⁻¹.

FIG. 28. FTIR spectrum of woven Cu-COF-506 highlighting the imine bond stretch at 1622 cm⁻¹. The formation of imine bonds is confirmed by the presence of a characteristic imine bond stretch at 1622 cm⁻¹.

FIG. 29. FTIR spectrum of woven Cu-COF-506 with tetrafluoroborate counter ions highlighting the imine bond stretch at 1622 cm⁻¹. The formation of imine bonds is confirmed by the presence of a characteristic imine bond stretch at 1622 cm⁻¹.

FIG. 30. Overlay of FTIR spectra of interlocked imine-linked (Cu-COF-500) and amide-linked (Cu-COF-501) COFs from 1000 cm⁻¹ 2000 cm⁻¹. The disappearance of characteristic imine C═N stretch and emergence of C═O stretch related to amide bond formation is highlighted.

FIG. 31. Overlay of FTIR spectra of woven imine-linked (Cu-COF-506) with diphenylphosphinate anions and amide-linked (Cu-COF-507) COFs from 1000 cm⁻¹ 2000 cm⁻¹. The disappearance of characteristic imine C═N stretch and emergence of C═O stretch related to amide bond formation is highlighted.

FIG. 32. Overlay of FTIR spectra of interlocked amide-linked metalated and demetalated COFs. No change is observed in the characteristic amide bond stretch after demetalation.

FIG. 33. Overlay of FTIR spectra of woven amide-linked metalated and demetalated COFs. No change is observed in the characteristic amide bond stretch after demetalation.

FIG. 34. FTIR spectrum of COF-300.

FIG. 35. FTIR spectrum of COF-791.

FIG. 36. FTIR spectrum of MOF-808.

FIG. 37. FTIR spectrum of MIL-53 (AI).

FIG. 38. Solid-state NMR spectra of ¹³C-labeled interlocked COF before and after oxidation. The signal at 158.0 ppm, which is related to the isotopically enriched imine bond carbon, disappears, and a new amide carbon signal at 164.4 ppm emerges.

FIG. 39. Solid-state NMR spectra of ¹³C-labeled woven COF before and after oxidation. The signal at 158.0 ppm, which is related to the isotopically enriched imine bond carbon, disappears and a new amide carbon signal at 164.4 ppm emerges.

FIG. 40A-D. Scanning electron micrograph images of woven and interlocked amide-linked COFs. (A) The SEM micrographs show nanometer-sized, rice-shaped crystals of Cu-COF-501 (MI). (B) The SEM micrographs show nanometer-sized, rice-shaped crystals of COF-501 (DMI). (C) The SEM micrographs show nanometer-sized, rod-shaped crystals of Cu-COF-507 (MW). (D) The SEM micrographs show nanometer-sized, rod-shaped crystals of COF-507 (DMW).

FIG. 41A-D. Scanning electron micrograph images of COF and MOF materials for comparison. (A) COF-300, (B) COF-791, (C) MIL-53(Al), and (D) MOF-808.

FIG. 42. SEM images from the fractured surface of PI.

FIG. 43. TGA of imine-linked Cu-COF-506 and amide-linked Cu-COF-507 under air atmosphere. Decomposition temperature is lowered from imine to amide linkage.

FIG. 44. TGA of imine-linked Cu-COF-500 and amide-linked Cu-COF-501 under air atmosphere. Thermal stability does not change after post-synthetic linkage conversion.

FIG. 45. TGA of imine-linked Cu-COF-506 and amide-linked Cu-COF-507 under nitrogen atmosphere.

FIG. 46. TGA of imine-linked Cu-COF-500 and amide-linked Cu-COF-501 under nitrogen atmosphere.

FIG. 47. TGA of polyimide (PI) and COF-polyimide composites with increasing filler loading of interlocked Cu-COF-501. Thermal stability decreases slightly with increasing filler loading.

FIG. 48. TGA of polyimide (PI) and COF-polyimide composites with increasing filler loading of woven Cu-COF-507. Thermal stability decreases slightly with increasing filler loading.

FIG. 49. Summary of benzene adsorption isotherms. The interlocked amide-linked Cu-COF-501 shows a benzene uptake of up to 26 wt. %. In comparison, the woven amide-linked Cu-COF-507 takes up about 19 wt. % of benzene. The choice of counter anion implemented prior to the oxidation process does not play an important role for the adsorption behavior.

FIG. 50. Summary of tetrahydrofuran (THF) adsorption isotherms. The interlocked amide-linked Cu-COF-501 shows a benzene uptake of up to 29 wt. %. In comparison, the woven amide-linked Cu-COF-507 takes up about 22 wt. % of benzene. The choice of counter anion implemented prior to the oxidation process does not play an important role for the adsorption behavior.

FIG. 51. Benzene adsorption isotherms of metalated and demetalated interlocked COFs. The uptake of benzene is lowered upon removal of the Cu(I) nodes.

FIG. 52. THE adsorption isotherms of metalated and demetalated interlocked COFs. The uptake of THF is not substantially lowered upon removal of the Cu(I) nodes.

FIG. 53. Benzene adsorption isotherms of metalated and demetalated woven COFs. The uptake of benzene is lowered upon removal of the Cu(I) nodes.

FIG. 54. THE adsorption isotherms of metalated and demetalated woven COFs. The uptake of THF is not substantially lowered upon removal of the Cu(I) nodes.

FIG. 55. ¹H digest NMR spectrum of Cu-COF-500 after soaking in PMDA compared to the ¹H NMR spectrum of PMDA.

FIG. 56. ¹³C digest NMR spectrum of Cu-COF-500 after soaking in PMDA compared to the ¹³C NMR spectrum of PMDA. Characteristic ¹³C signals can be related to the presence of PMDA in the COF.

FIG. 57. ¹H digest NMR of Cu-COF-500 after soaking in PMDA. A characteristic 1H signal can be related to PMDA in a ratio of 1:1 compared to the building blocks of the COF.

FIG. 58. ¹H digest NMR of demetalated COF-500 after soaking in PMDA. A characteristic ¹H signal can be related to PMDA in a ratio of 0.5:1 compared to the building blocks of the COF.

FIG. 59. ¹H digest NMR of Cu-COF-506 after soaking in PMDA. A characteristic 1H signal can be related to PMDA in a ratio of 0.25:1 compared to the building blocks of the COF.

FIG. 60. ¹H digest NMR of demetalated COF-506 after soaking in PMDA. A characteristic ¹H signal can be related to PMDA in a ratio of 0.5:1 compared to the building blocks of the COF.

FIG. 61. ¹H digest NMR spectrum of Cu-COF-500 after soaking in ODA compared to the ¹H NMR spectrum of ODA.

FIG. 62. ¹³C digest NMR spectrum of Cu-COF-500 after soaking in ODA compared to the ¹³C NMR spectrum of ODA. Characteristic ¹³C signals can be related to the presence of PMDA in the COF.

FIG. 63. ¹H digest NMR of Cu-COF-500 after soaking in ODA. A characteristic 1H signal can be related to ODA in a ratio of 0.15:1 compared to the building blocks of the COF.

FIG. 64. ¹H digest NMR spectrum of Cu-COF-506 after soaking in ODA. A characteristic ¹H signal can be related to ODA in a ratio of 0.13:1 compared to the building blocks of the COF.

FIG. 65. ¹H digest NMR spectrum of Cu-COF-500 after subsequent soaking in PMDA and ODA. Characteristic ¹H signals can be related to ODA and PMDA in a ratio of 0.5:0.9:1 compared to the building blocks of the COF.

FIG. 66. Size exclusion experiment with 2,7-di-tert-butylpyrene. No residual peaks were detected after soaking Cu-COF-500 in a solution with 2,7-di-tert-butylpyrene.

FIG. 67A-F. TEM images and particle analysis of the PI-MW composites. (A) PI-MW (1 wt. %). (B) PI-MW (3 wt. %). (C) PI-MW (5 wt. %). The particle distribution profiles from the TEM images of (D) PI-MW (1 wt. %), (E) PI-MW (3 wt. %), and (F) PI-MW (5 wt. %).

FIG. 68A-F. TEM images and particle analysis of the PI-MI composites. (A) PI-MI (1 wt. %). (B) PI-MI (3 wt. %). (C) PI-MI (5 wt. %). The particle distribution profiles from the TEM images of (D) PI-MI (1 wt. %), (E) PI-MI (3 wt. %), and (F) PI-MI (5 wt. %).

FIG. 69A-B. WAXS profiles of the plastically deformed PI-COF composites.

FIG. 70A-C. WAXS profiles of the plastically deformed PI-COF composites. (A) A representative diffraction pattern of the stretched PI-COF composites. (B) WAXS studies comparing unstretched PI, PI-MW, and PI-MI. (C) WAXS studies of pre-stretched samples of PI, PI-MW, and PI-MI, showing an increased orientation of polymer chains from PI to PI-MW.

FIG. 71A-C. Comparison of molecular interactions between metalated and demetalated woven/interlocked COFs and polymer matrix.

FIG. 72A-B. WAXS profiles of the PI-COF-791 and PI-MOF-808 composites.

FIG. 73. Strength and toughness comparisons of COF composites with different sample preparation conditions.

FIG. 74. Engineering stress-strain curves of PS and PS-MW (3 wt. %).

FIG. 75. FTIR spectrum of the model compound for the passivation reaction of amines with trifluoroacetic anhydride. The carbonyl characteristic amide carbonyl stretch as well as the C-F bond stretches are highlighted.

FIG. 76. NMR spectra of the model compound for the passivation reaction of amines with trifluoroacetic anhydride. After digestion, a small portion of the amide bonds is broken to form trifluoroacetic acid (TFA).

FIG. 77. Overlay of FTIR spectra of interlocked Cu-COF-500 before and after passivation with trifluoroacetic anhydride. The highlighted signals indicate the formation of amide bonds through the reaction of TFAA with open amine functional groups, thereby exhibiting characteristic C-F signals. Furthermore, the characteristic imine bond signal remains unchanged after passivation.

FIG. 78. Overlay of FTIR spectra of woven Cu-COF-506 before and after passivation with trifluoroacetic anhydride. The highlighted signals indicate the formation of amide bonds through the reaction of TFAA with open amine functional groups, thereby exhibiting characteristic C-F signals. Furthermore, the characteristic imine bond signal remains unchanged after passivation.

FIG. 79. Overlay of FTIR spectra of interlocked Cu-COF-501 before and after passivation with trifluoroacetic anhydride. The highlighted signals indicate the formation of amide bonds through the reaction of TFAA with open amine functional groups, thereby exhibiting characteristic C-F signals.

FIG. 80. Overlay of FTIR spectra of woven Cu-COF-507 before and after passivation with trifluoroacetic anhydride. The highlighted signals indicate the formation of amide bonds through the reaction of TFAA with open amine functional groups, thereby exhibiting characteristic C-F signals.

FIG. 81. The structure of MI represented in different directions.

FIG. 82. The structure of MW represented in different directions.

FIG. 83A-K. Modulus mapping using Nano DMA of pristine MW and MI crystals. (A) 1D histograms of the modulus mapping of storage modulus of MW and MI crystals with fitting curves. (B-C) Scanned images (height) of MW and DMW, respectively. (D-G) Gaussian fittings of the modulus mapping results of MW, DMW, MI, DMI, respectively. In case of MW and MI, the curves were deconvoluted into two gaussian peaks. (H-I) 2D modulus mappings of MW (H), DMW (I), MI (J), DMI (K), respectively, ranging from 0 to 3 GPa.

### DESCRIPTION OF PARTICULAR EMBODIMENTS OF THE INVENTION

Unless contraindicated or noted otherwise, in these descriptions and throughout this specification, the terms “a” and “an” mean one or more, the term “or” means and/or. It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein, including citations therein, are hereby incorporated by reference in their entirety for all purposes.

### Amide-Linked Woven and Interlocked Covalent Organic Frameworks

The synthesis of amide-linked woven and interlocked COFs described herein is based on the post-synthetic modification of woven and interlocked imine-based COFs by oxidation, thereby introducing chemically irreversible amide-linkages. The synthetic strategy of imine-linked COF-500 and COF-506 is based on our recent reports on interlocked and woven covalent organic frameworks.^{4, 5} The original COF is then oxidized to the amide-linked COF-501 and -507. For the oxidation reaction, the protocol developed by Yaghi et al. was followed.⁶ This protocol allows for the oxidation of the imine to the amide functionality with NaClO₂ as oxidation reagent in dioxane with acetic acid and 2-methyl-2-butene over 6 days. The successful oxidation process was confirmed by Fourier-transform infrared spectroscopy (FT-IR) and CP-MAS solid-state NMR spectroscopy.

After synthesis and characterization of COF-501 and -507, the copper (I)-salt is removed through extensive washing with 1M methanolic solution of potassium cyanide (KCN) at 75° C. The removal of the metal complex results in a loss in long-range periodicity, caused by the spatial rearrangement of the structure, transforming the covalent organic framework structures into dynamic interlocked/woven polymeric materials. Demetallation drastically alters the mechanical properties of the crystalline materials. (Metallated COFs are differentiated from the demetallated COFs by stating the incorporated metal ions in their names.)

Following the synthesis and characterization of the chemically stable amide-based interlocked and woven material, we studied the elasticity and toughness of the new materials. Metallated and demetallated COF-501 and -507 were subjected to nanoindentation experiments by a conical tip of an atomic force microscope (AFM). The load-displacement curves were recorded for the loading and the unloading process. The Young's moduli of the interlocked and the woven polyamides were compared to conventional polyamides. The nanoindentation was performed in load-controlled mode using a conical tip (Hysitron TI-950 Triboindenter). Each COF was prepared by depositing onto pieces of Si wafer. Hereby, the film thickness and casting conditions was optimized according to the material properties. The nanoindentation experiments were conducted at room temperature and at variable temperatures.

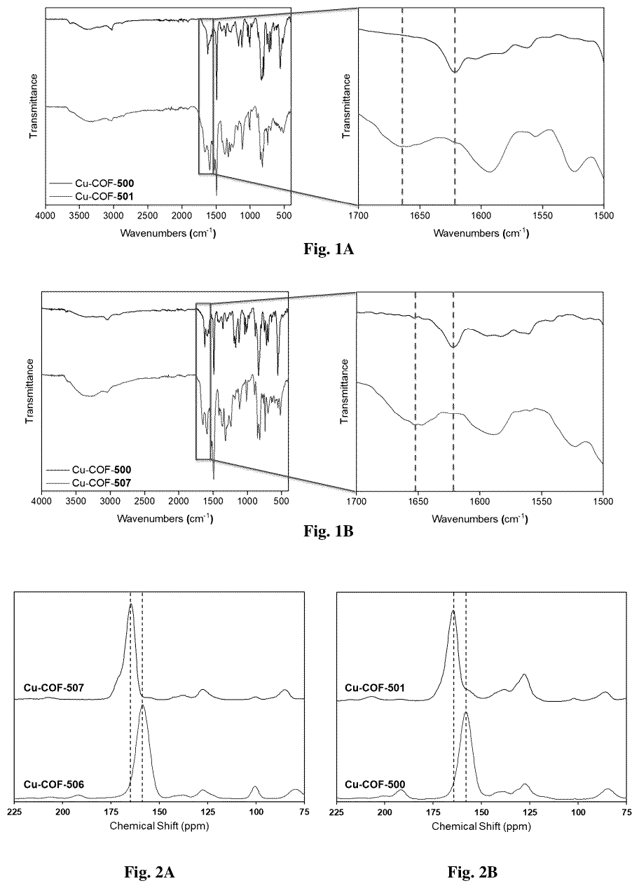

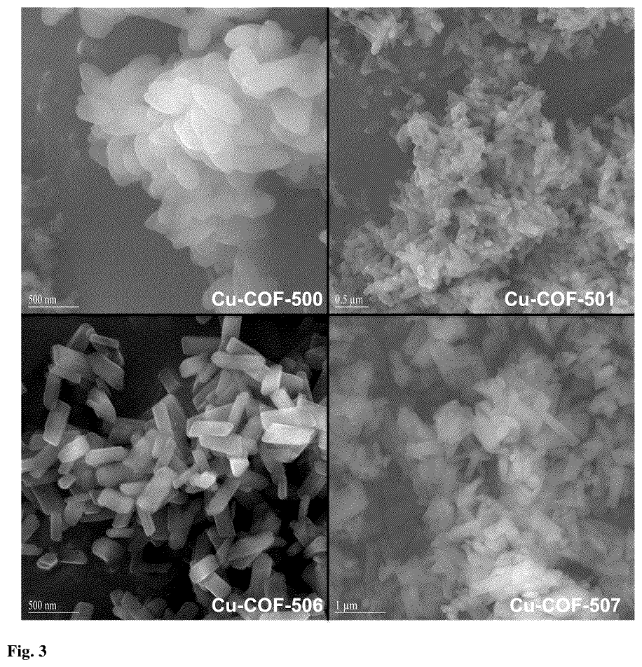

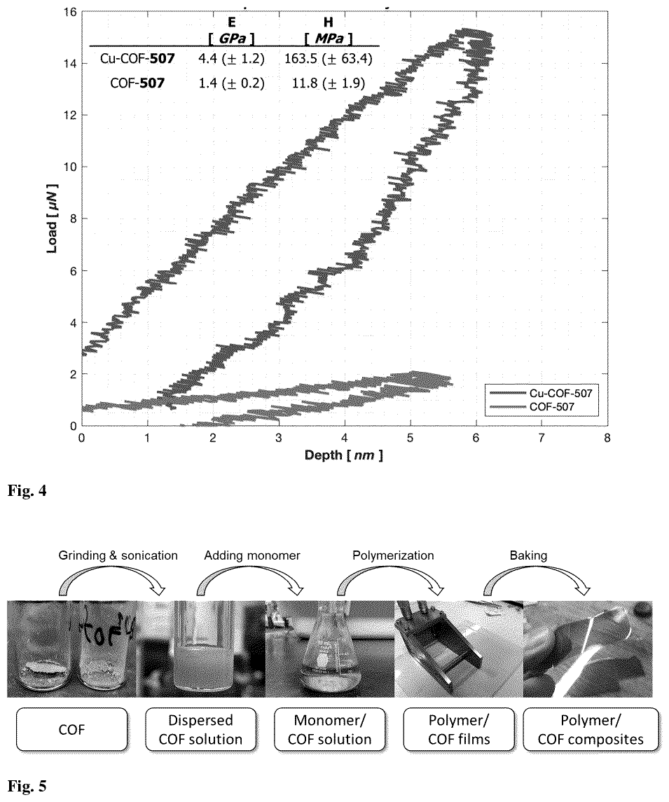

FT-IR spectroscopy (FIG. 1A-B) and ¹³C solid-state CP-MAS NMR spectroscopy (FIG. 2A-B) indicate a complete conversion from imine to amide functionalities in the framework materials. After post-synthetic linkage oxidation, the characteristic C═N stretch at 1622 cm⁻¹ observed in the imine-linked COFs disappears, whereas a characteristic C═O stretch at 1660 cm-1 emerges in the amide-linked COFs. This is supported by the change in chemical shift in the NMR spectra. The signal at 157 ppm is related to the carbon atom involved in the imine bond and is shifted to 162 ppm, thereby confirming the successful oxidation from imine to amide. SEM micrographs (FIG. 3) taken before and after the oxidation process show that the crystal size, shape, and morphology for both the woven and interlocked COFs remain intact throughout the process. Nanoindentation studies were used to elucidate the effect of demetallation on the mechanical properties of the materials. As expected, both hardness and clastic modulus (stiffness) are reduced after demetallation of the woven COF, thereby resulting in a softer, more clastic material.

The disclosed process enables the synthesis of amide-linked woven and interlocked COFs that are comprised of a tetrahedral weaving-node and linear/square-planar building blocks. Generally, this process can be adapted to oxidize any imine-linked woven and interlocked COF to transform them into chemically stable, amide-linked COFs. These materials exhibit exceptional mechanical behavior, which can be altered by removing and reinstating the metal ions that coordinate the weaving nodes.

### Woven and Interlocked COF-Polymer Nanocomposites

After successful synthesis and characterization of the interlocked/woven amide covalent organic framework particles, the COF crystallites can be interfaced with polymer matrices through different interactions. The abundance of the reactive functional amine and carboxylic acid groups on the surface of the particles can be used to chemically integrate the interlocked/woven polyamide segments into conventional polyamides. This requires the repeated joining of the reactive carboxylic acid/amine-groups on the interlocked/woven particles with the corresponding counterparts to form the extended amide polymers. The use of conventional polymers such as polyimides allows such copolymerization with interlocked/woven polyamides. Among the conventional polyimides, the co-polymerization with aliphatic linkers can be employed to obtain materials, such as in nylon. The use of aromatic linkers results in materials like aramids and Kevlar®. Furthermore, physical mixing and entanglement of polymer chains within the woven and interlocked covalent organic framework structures do not rely on the forming of chemical bonds between the COF crystallites and the polymers to alter the mechanical properties of the resulting composites. This allows the use of COF fillers in composites with polymers that are unreactive to the functional groups at the surface of the COFs. In any case, woven and interlocked COFs are anticipated to drastically improve the mechanical properties of the resulting COF/polymer composites.

Studies of elasticity and toughness of the co-polymerized materials allow for comparisons to conventional polymers without interlocked/woven segments. The larger quantity of the material allows us to study the tensile strength of the materials though uniaxial tensile tests performed on a screw-driven mechanical testing machine (Instron-5933, Norwood, MA) with a 2 kN maximum load cell. The co-polymers are dry-casted on the customized Teflon mold at room temperature after removing air bubbles with controlling pressure. The dried films (thickness of ˜300 μm) are cut into dog-bone specimens with an ASTM D1708 cutting die. Mechanical behaviors of the co-polymerized materials and conventional polyamides are comparable and the values of elasticity, toughness, and elongation at break are measured.

The copolymerization synthesis of COF-polyimide films presented herein follows a procedure displayed in FIG. 5. After physically grinding the amide-based COF n-methyl-2-pyrrolindone (NMP) is added as a solvent followed by subsequent sonication and tip sonication which breaks up the crystallites and allows the formation of a fine dispersion. To the COF dispersion is then added 4,4′-Oxydianiline (ODA) followed by sonication to allow the inclusion of the monomer into the homogeneously distributed COF particles. Pyromellitic dianhydride (PMDA) is added and the reaction mixture is kept stirring under nitrogen atmosphere at 75° C. for 24 h. To generate even COF-polyimide films, a doctor blade is used before the solvent is evaporated and the imidization is completed at raised temperatures up to 300° C.

### Mechanical Properties of Polyimide Films and Different COF-Polyimide Composites.

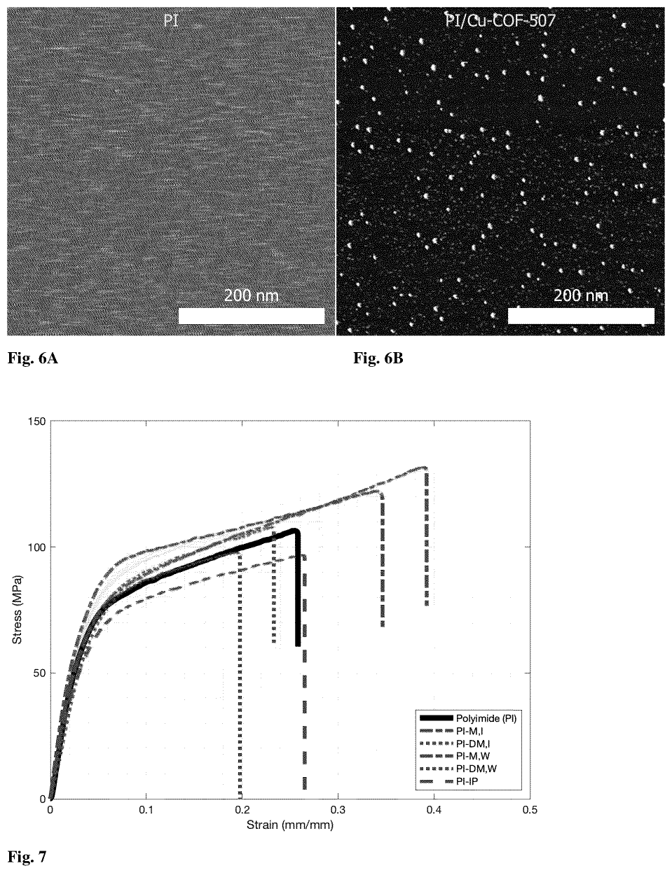

Confirmation of homogeneously distributed woven and interlocked COF particles in the polymer film, AFM micrographs were taken. The micrographs in FIG. 6A-B compare pure polyimide films with polyimide films that use metallated, amide-linked, woven Cu-COF-507 as a filler material. Whereas the pure polyimide film shows an even surface, the COF/polymer composite shows an even distribution of filler material within the polymer matrix. The mechanical properties of different COF/polyimide composites were compared with pure polyimide films by measuring stress-strain curves for a set of dog bone samples. (FIG. 7) The collected data is shown in Table 1 and indicate that the use of woven and interlocked COF crystallites as fillers enhances both the elastic modulus as well as the hardness of the composites. In comparison, the use of well-known COF-300 as filler material showed a decrease in elastic modulus.

The process described herein can be adapted and generalized for the use of woven and interlocked COFs including but not limited to imine- and amide-bonded COFs. Furthermore, the herein described process can be adapted for a wide variety of polymers including but not limited to polyamide, polyimide, polyester, polyether, polyamine, polyethylene, and polystyrene.

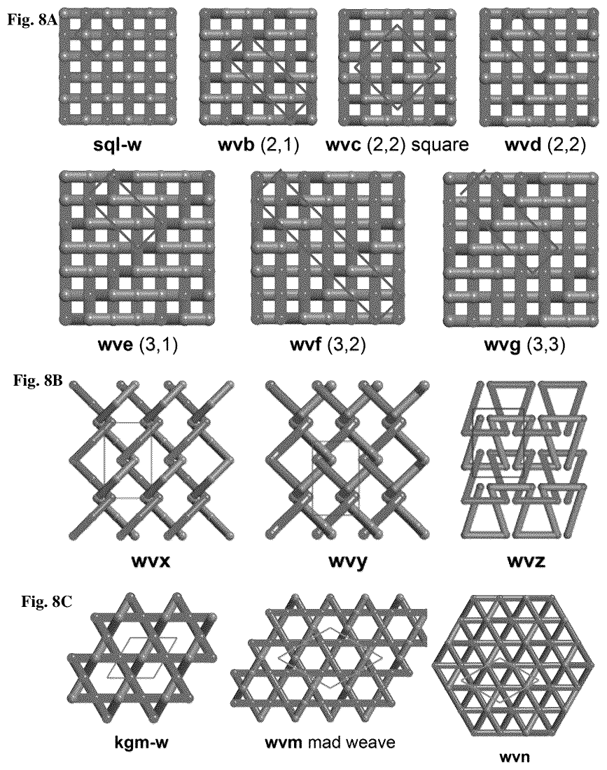

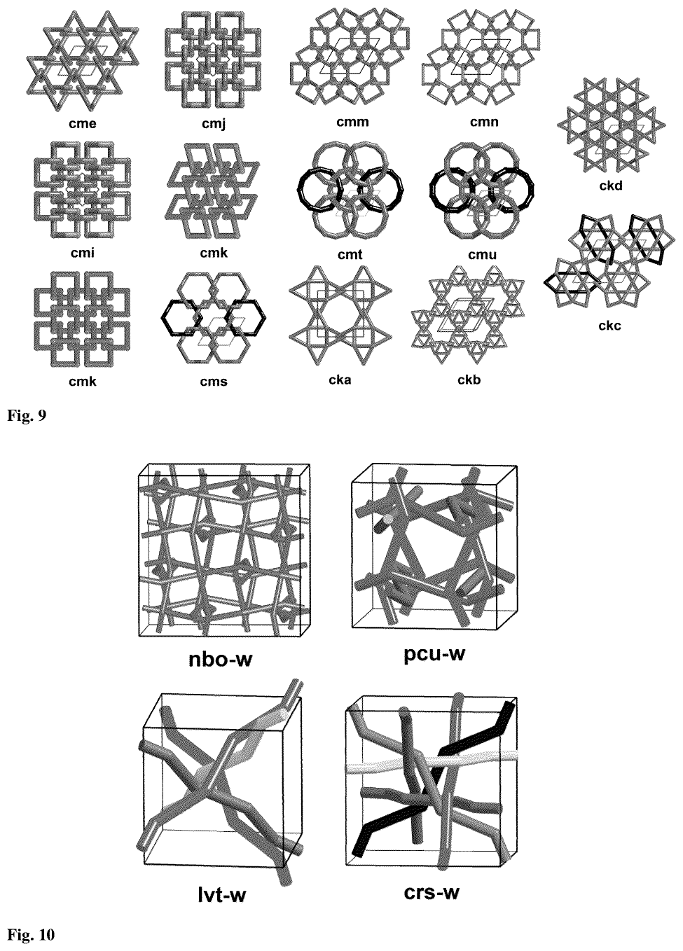

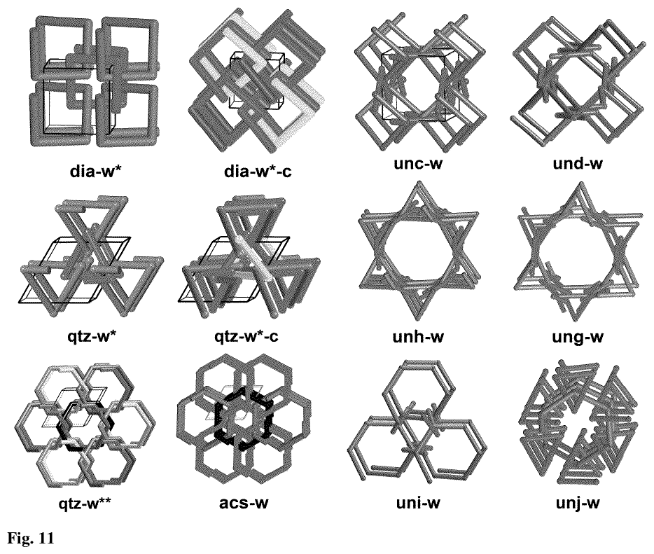

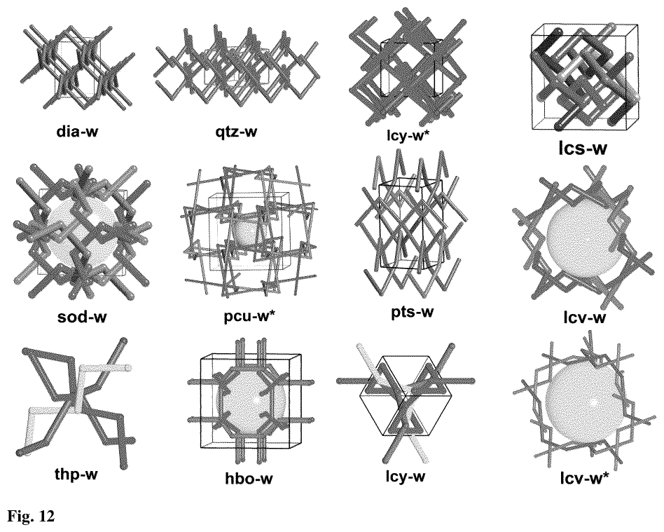

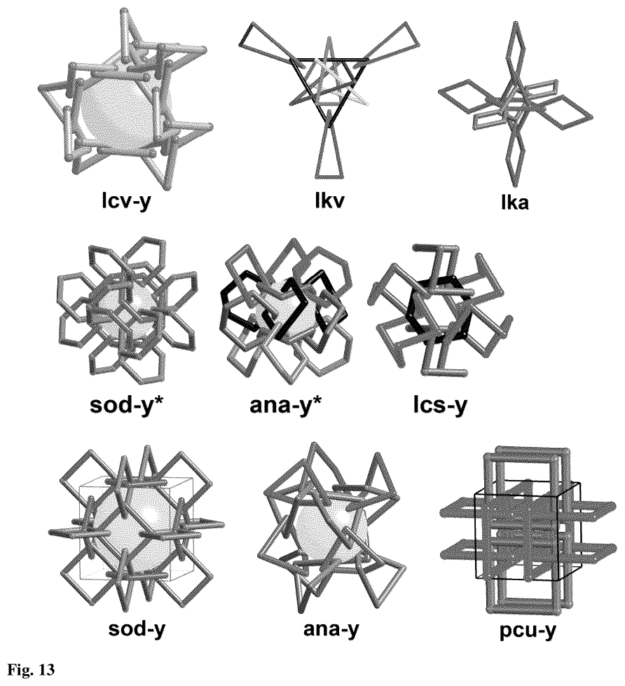

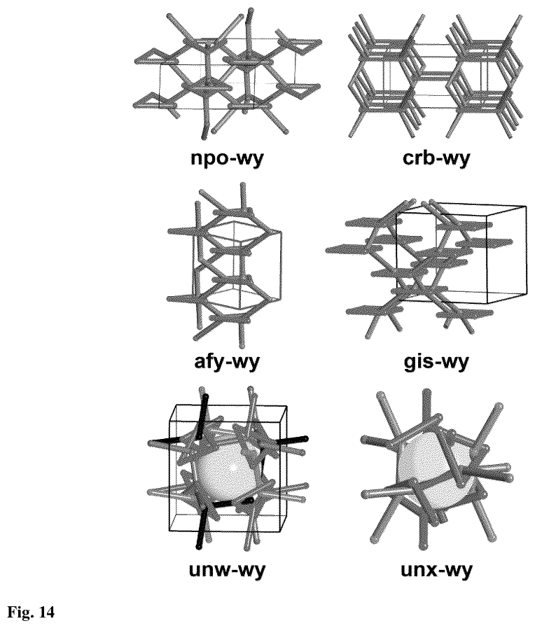

The invention encompasses structures and nets (e.g. FIG. 8-14) comprising alternative woven and interlocked structures and nets to improve the mechanical properties of COF/polymer nanocomposites following the disclosed method of incorporation.⁷

### REFERENCES

1. Bockstaller, M. R.; Mickiewicz, R. A.; Thomas, E. L. Adv. Mater. 2005, 17, 1331-1349.
2. Hoheisel, T. N.; Hur, K.; Wiesner, U. B. Prog. Polym. Sci. 2015, 40, 3-32.
3. Sarkar, B.; Alexandridis, P. Prog. Polym. Sci. 2015, 40, 33-62.
4. Liu, Y.; Diercks, C. S.; Ma, Y.; Lyu, H.; Zhu, C.; Alshmimri, S. A.; Alshihri, S.; Yaghi, O. M. J. Am. Chem. Soc. 2019, 141, 677-683.
5. Liu, Y.; Ma, Y.; Yang, J.; Diercks, C. S.; Tamura, N.; Jin, F.; Yaghi, O. M. J. Am. Chem. Soc. 2018, 140, 16015-16019.
6. Waller, P. J.; Lyle, S. J.; Osborn Popp, T. M.; Diercks, C. S.; Reimer, J. A.; Yaghi, O. M. J. Am. Chem. Soc. 2016, 138, 15519-15522.
7. Liu, Y.; O'Keeffe, M.; Treacy, M. M. J.; Yaghi, O. M. Chem. Soc. Rev. 2018, 47, 4642-4664.

TABLE 1
Mechanical properties of polyimide films and different
COF-polyimide composites.

| Samples | 1 | 2 | 3 | 4 | 5 | 6 |
|---|---|---|---|---|---|---|
| 01. | 2371.25 | 72.6 | 0.0518 | 104.93 | 0.25504 | 22.09 |
| Kap- | (±201.45) | (±5.76) | (±0.0030) | (±15.63) | (±0.0975) | (±11.95) |
| ton ® | | | | | | |
| (Poly- | | | | | | |
| imide) | | | | | | |
| 02. | 2602.71 | 76.07 | 0.0500 | 128.97 | 0.35529 | 35.81 |
| PI-M, | (±164.88) | (±5.39) | (±0.0026) | (±14.57) | (±0.0657) | (±9.17) |
| I | | | | | | |
| 03. PI- | 2489.04 | 76.99 | 0.0517 | 107.29 | 0.20393 | 17.66 |
| DM, I | (±234.08) | (±3.55) | (±0.0027) | (±8.81) | (±0.0699) | (±7.27) |
| 04. | 2789.98 | 83.84 | 0.0507 | 114.63 | 0.27816 | 29.91 |
| PI-M, | (±119.4) | (±5.6) | (±0.0032) | (±8.13) | (±0.0760) | (±6.19) |
| W | | | | | | |
| 05. PI- | 2438.65 | 80.35 | 0.0543 | 110.12 | 0.22714 | 20.95 |
| DM, W | (±310.88) | (±2.68) | (±0.0045) | (±13.13) | (±0.0854) | (±11.13) |
| 06. | 2620.93 | 72.96 | 0.0479 | 98.55 | 0.21182 | 17.24 |
| PI-IP | (±213.91) | (±7.81) | (±0.0010) | (±4.24) | (±0.0910) | (±7.96) |

1: Modulus (E, MPa); 2: Yield Stress (σy, MPa); 3: Yield Strain (εy, mm/mm); 4: Fracture Stress (σf, MPa); 5: Fracture Strain (εf, mm/mm); 6: Toughness (MPa)

TABLE 2
Geometric data for 2-periodic weavings.

| Symbol | Trans | Symmetry | Cell a, b | Corner | Stick(s) |
|---|---|---|---|---|---|
| wva (1, 1) | 1 1 1 | p4/nbm | 1.414, 1.414 | 1/4, 1/4, z | 3/4, 3/4, −z |
| wvb (2, 1) | 2 2 1 | c222 | 1.714, 4.247 | 0, 0, z | 0.063, 1/2, −z |
| | | | | 0, 0.333, z | 0.167, 1/2, z |
| wvc (2, 2) | 1 2 1 | p4/nbm | 2.828, 2.828 | 0, 1/4, z | 1/4, 0, −z, −1/4, 0, z |
| wvd (2, 2) | 1 2 1 | pbaa | 2.818, 1.414 | 0.375, 1/4, z | 0.625, 3/4, −z; 0.125, −1/4, z |
| wve (3, 1) | 2 2 1 | p222 | 1.414, 2.828 | 0, 0, z | 0.25, 1/2, −z; 0.75, −1/2, −z |
| | | | | 0.25, 1/2, −z | |
| wvf (3, 2) | 2 3 1 | c222 | 1.414, 7.070 | 0, 0.2, z | −1/2, 0.3, z; 1/2, 0.1, −z; |
| | | | | 0, 0.4, z | 1, 0.6, z |
| wvg (3, 3) | 1 2 1 | pban | 4.247, 1.414 | 0.083, 3/4, z | −0.083, 1/4, −z; 0.417, 3/4, z |
| kgm-w (1, 1) | 1 1 1 | p622 | 1.0, 1.0 | 0, 1/2, z | 1/2, 0, −z |
| wvm (3, 3) | 1 2 1 | p622 | 1.732, 1.732 | 0.167, 0.833, z | 0.333, 1.167, −z; −0.167, 1.167, z |
| wvx | 2 1 1 | c222 | 1.4, 2.8 | 0.15, 0, 0 | −0.25, 0.25, z |
| | | | | −0.25, 0.25, z | |
| wvy | 2 2 1 | pban | 1.4, 2.8 | 0.4, 1/4, 0 | 1/4, 0.35, z; 1/4, 0.15, −z |
| | | | | 1/4, 0.35, z | |
| wvz | 1 2 1 | pbam | 3.0, 4.0 | 0.35, 0.85, −z | 1.15, 0.85, −z; |
| | | | | | 0.65, 0.15, z |

TABLE 3
Geometric data for 2-periodic polycatenanes (interlocked systems).

| Symbol | Link points | Trans | Sym | Corner | Stick(s) |
|---|---|---|---|---|---|
| cme | kgm | 2 2 1 | p622 | 0.583, 0.167, 0 | 0.58, 0, z; 0.42, 0.42, −z |
| | | | | 0.583, 0, z | |
| cmj | sql | 2 2 1 | p422 | 0, 0.3, 0 | −0.2, 0.5, z; 0.5, 0.8, z |
| | | | | 0.5, 0.8, z | |
| cmi | sql | 2 1 1 | p4̅2m | 0.3, 0, 0 | 0.65, 0.35, z |
| | | | | 0.63, 0.35, z | |
| cmk | sql | 1 2 1 | pbmn | 0.15, 0.15, z | 0.85, 0.15, −z; 0.15, 0.85, z |
| cms | kgm | 2 1 1 | p622 | 0.4, 0, 0 | 0.6, 0.2, z |
| | | | | 0.6. 0.2, z | |
| cmt | htb | 2 1 1 | p3̅1m | 0.61, 0.39, 0 | 0.32, 0, z |
| | | | | 0.32, 0, z | |
| cmu | htb | 1 2 1 | p622 | 0.21, 0.79, z | 0.58, 0.79, −z; −0.21, 0.58, −z |

TABLE 4
Geometric data for 3-periodic fabric weaving.

| Symbol | Symmetry | Corner | Stick |
|---|---|---|---|
| nbo-w | Fd3̅c | 7/8, 7/8, −0.024 | 1/8, 0.774, 1/8 |
| lvt-w | I4₁22 | 0.5, 0.7, 0.68 | 0.2, 1.0, 0.83; 0.7, 0.5, 0.33 |
| pcu-w | I432 | 3/4, 0.413, 0.087 | 1/4, 0.087, 0.413 |
| crs-w | F4₁32 | 0.29, 0.46, 5/8 | 0.71, 0.54, 5/8 |

TABLE 5
Geometric data for 3-periodic chain-link weaving with parallel threads.

| Symbol | Symmetry | Corner | Stick |
|---|---|---|---|
| dia-w* | I4₁22 | 0.25, 0.25, 0 | 0.25, −0.75, 1/4 |
| dia-w*-c | P4₂22 | 0.0, 0.3, 0.5 | 0.7, 1.0, 0.0 |
| qtz-w* | P6₂22 | 0.25, 1 − x, 1/3 | 2x − 1, x 2/3 |
| qtz-w*-c | P6₂22 | 0.44, 0.88, 0 | 0.44, 1.16, 1/3 |
| qtz-w** | P6₂22 | 0.764, 0, 0 | 0.764, 0.764, 1/3 |
| acs-w | P6₃22 | 1, −0.505, 1/4 | 1.01, 1.505, 3/4 |
| unc-w | P4₁22 | 0.44, 0, 3/4 | 0, 0.56, 1/2 |
| | | 0, 0.22, 0 | 0, 0.78, 1/2 |
| und-w | I4₁/amd | 3/4, 0.4, 0 | 3/4, 0.1, 1/2 |
| | | 1/4, 0.28, 1/2 | 0.47, 1/2, 1/4 |
| unh-w | P6₁22 | 0.48, 0.96, 0.25 | 0.48, 0.52, 0.92 |
| | | 0.38, 0.76, 0.25 | 0.62, 0.25, 0.75 |
| ung-w | R3̅c | 0, 0.47, 1/4 | 0.14, 1/3, 7/12 |
| | | 0, 0.39, 1/4 | 0, 0.61, 3/4 |
| uni-w | P6₁22 | 0.46, 0, 0 | 0.46, 0.46, 1/6 |
| | | 0.32, 0, 0 | 0.68, 0, 1/2 |
| unj-w | P6₁22 | 0.32, 0.16, 1/12 | 0.84, 0.16, 5/12 |
| | | 0.31, 0.62, 1/4 | 0.62, 0.31, 1/12 |

TABLE 6
Geometric data for 3-periodic chain-link
weaving with non-parallel threads.

| Symbol | Symmetry | Corner | Stick | Thread |
|---|---|---|---|---|
| dia-w | I4₁/amd | 0, 3/4, 0.434 | 0, 1/4, 0.434 | 2₁ ϑ |
| dia-w-e | PA₂/nnm | 1/4, 3/4, 0.85 | −1/4, 1/4, 0.15 | 2₁ Φ |
| qtz-w | P6₂22 | 1/2, 1/2, 0.008 | 0, 1/2, 0.992 | 2₁ Λ |
| pts-w | P4₁22 | 0, 0, 0.17 | −1/2, 0.12, 1/2 | 2₁ Φ |
| sod-w | I432 | 0.069, 1/4, 0.431 | −0.069, 0.569, 3/4 | 3₁ Ω |
| lcs-w | Ia3̅d | 3/4, 0.488, 0 | 3/4, 0.512, −1/4 | 4_{1,3} Π* |
| lev-w | I4₁32 | 0.458, 0.708, 5/8 | 0.792, 5/8, 0.542 | 3₁ Σ |
| lcv-w* | I4₁32 | 0.075, 0, 1/4 | 1/4, 0.175, 0 | 3₁ Σ |
| lcy-w | P4₁32 | 3/8, 1.539, 0.211 | 0.461, 0.711, 1/8 | 3₁ Σ |
| lcy-w* | P4₁32 | 7/8, -0.008, 0.742 | 3/8, 0.508, 0.242 | 2₁ Π |
| thp-w | I4̅3d | 0.80, 0.18, 0.03 | 0.32, 0.03, 0.20 | 3₁ Γ |
| dia-w ** | F4₁32 | 1/4, 1/4, 0.63 | 0.62, 0, 0 | 4₁ Π* |
| hbo-w | Pm3̅n | 0.62, 0.29, 0.83 | 0.32, 0.29, 1.17 | — |

TABLE 7
Geometric data for polycatenanes (interlocked systems).

| Symbol | Symmetry | Corner | Stick |
|---|---|---|---|
| lcv-y | I4₁32 | 0.44, 0.19, 7/8 | 0.81, 3/8, 1,06 |
| lkv | F432 | 0.3, 0, 0,7 | 0, 0.3, 1.3 |
| sod-y | Im3̅m | 0.19, 0, 1/2 | 1/2, 0, 0.19 |
| ana-y | Ia3̅d | 0.89, 0.42, 0.81 | 0.83, 0.14, 0.94 |
| lka | Fm3̅c | 1/2, 0.2, 0 | 0.35, 1/2, 0 |
| sod-y* | Pn3̅m | 0.31, 1/2, 0.69 | 0, 0.19, 0.69 |
| ana-y* | Ia3̅d | 0.17, 0.30, 0.89 | 0.20, 0.39, 1.17 |
| peu-y | Pm3̅n | 0.1, 0.4, 3/4 | 0.9, 0.4, 3/4 |

TABLE 8
Geometric data for thread plus ring weavings.

| Symbol | Symmetry | Corner | Stick |
|---|---|---|---|
| npo-wy | P6₅/mmc | 0.47, 0.53, 1/4 | 0, 0.53, 1/4 |
| | | 0.41, 0.82, 1/4 | 0.59, 1.18, 3/4 |
| crb-wy | I4/mmm | 0.72, 0.28, 1/2 | 0.72, 0.72, 1/2 |
| | | 0.17, 0.17, 0 | 0.33, 0.33, 1/2 |
| afw-wy | R32 | 0.125, 0, 0 | 0.542, 0.208, 1/3 |
| | | 1/3, 0.6, 1/3 | 0.4, 0.067, 1/3 |
| gis-wy | I4₁/amd | 0.1, 0.35, 7/8 | 0.4, 0.35, 5/8 |
| | | 0.1, 0.45, 7/8 | 0.2, 0.05, 7/8 |
| unw-wy | I432 | 1/4, 0.19, 0.31 | 0.19, 1/4, 0.61 |
| | | 1/4, 0.08, 0.42 | 0.08, 0.42, 1/4 |
| unx-wy | I4₁32 | 0.125, 0, 1/4 | 1/4, 0.125, 0 |
| | | 1/8, 0.06, 0.19 | 3/8, 0.06, 0.31 |

### Examples

### Covalent Organic Frameworks Template Polymer Entanglements

Abstract: The introduction of molecularly woven 3D COF crystals into amorphous and liquid-crystalline polymers induces the formation of polymer-COF junctions. These junctions are generated by the threading of polymer chains through the pores of the nanocrystals, thus allowing for spatial arrangement of polymer strands. This offers a programmable pathway for unthreading polymer strands under stress and leads to the in situ formation of high-aspect-ratio nanofibrils, which dissipate energy during the fracture. Polymer-COF junctions also strengthen the filler/matrix interfaces and lower percolation thresholds of the composites, which leads to the dramatic enhancement of strength, ductility, and toughness of the composites by adding small amounts (˜ 1 wt. %) of COF nanocrystals. The topology of COF crystals is highlighted as the main parameter to form these junctions affecting the polymer chain penetration and conformation.

### Main Text:

Polymer chain entanglements are the very foundation governing polymer structure-property relationships and plastic engineering (1, 2). There are extensive efforts to modulate how polymers are entangled by using interpenetrating networks (3, 4), supramolecular hosts (5), polymer-grafted nanoparticles (PGNPs) (6, 7), and nanoconfinement (8). Major advancements have been made through improving network perfection in gels instead of polymer solids that most plastic products are based upon. PGNPs can modulate the directionality and local density of entanglements (9, 10), but are limited by the failure at particle/grafted polymer interfaces. When polymers are threaded through porous covalent organic frameworks (COFs), the crystalline order of the COF structure templates the spatial arrangements of polymer chains and offers pathways for unthreading under stress. This changes the modes of how composites dissipate energy under stress from being largely by bond rupture to long-chain pull-out and extension at such junctions. Since each COF nanocrystal can template numerous polymer chains, the pulled-out chains form high-aspect-ratio nanofibrils under stress in situ, resulting in macroscopically improved damage tolerance in polymer-COF composites in the form of strength, ductility, and improved resistance to fracture (toughness).

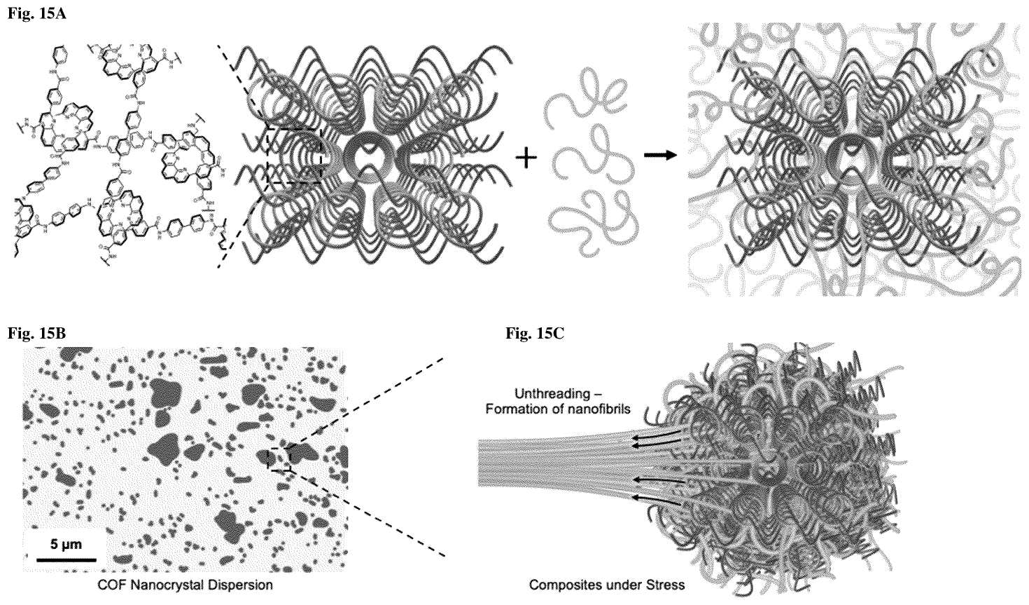

In the blends of polymer and COF nanocrystals (FIG. 15A), hundreds of polymer chains are templated with periodic control when the polymer-COF junctions are formed. The polymer segments pending on the surfaces of COF nanocrystal enhance COF nanocrystal's solubility for better dispersion (FIG. 15B) and strengthen the filler/matrix interface by bridging the woven COF particles and the matrix. At the molecular level, the threaded polymers within the COF units are analogous to polymer-polymer junctions (11) but could offer the reversibility of the entanglements of the polymer. By forming polymer-COF junctions, there is no need to chemically crosslink the host polymer to enhance the mechanical property, and the blends are more amenable to recycling (12). Fundamentally atomically defined, crystalline COF networks can realize topological control over polymer entanglements to probe the spatial arrangements of a long chain at monomer level (13).

Here we tested these hypotheses by blending COF nanocrystals (1-5 wt. %) and amorphous and liquid crystalline polymers, respectively. Upon mechanical deformation, numerous high-aspect-ratio nanofibers form at the fracture surface as a result of the unthreading of polymers from COF nanocrystals under stress (FIG. 15C). The effect of the polymer-COF junction goes beyond COF nanocrystal/matrix interfaces as the blends can effectively dissipate energy uniformly. This leads to enhancements in strength, ductility, and toughness, hence conferring damage tolerance. Polymer-COF junction formation is entropy driven and governed by polymer chain conformation. Molecularly, the polymer penetration depth and conformation inside COF crystals, the topology of polymer-COF junctions, and the morphology of polymer nanofibers depend on the COF crystal structure and reflect a balance between the statistical contribution of the torsion angle distribution for a polymer chain and the geometric constraints imposed by each COF unit cell.

### Selection of COF Nanocrystals

Nanocrystals of COFs and metal organic frameworks (MOFs), including COF-500 (14), COF-506 (15, 16), COF-300 (17), COF-791 (18), MOF-808 (19), and MIL-53 (20) were tested. Prior studies into the effect of mechanical bonding in polymers involved mechanically interlocked molecules such as rotaxanes and catenanes (21-23). Here, we chose to work with two types of molecularly defined, porous 3D nanocrystals, referred to as mechanically woven (MW) and mechanically interlocked (MI) COFs. Molecular weaving was first reported in imine-linked COFs (24, 25). While imine linkages can be exploited to generate crystalline extended structures, they generally lack chemical stability (26). To overcome this challenge, we oxidized the imine linkages to form chemically resilient amides via post-synthetic modification (27). Powder X-ray diffraction (PXRD) analysis of the resulting microcrystals confirmed the crystallinity of the resulting woven amide-linked COF (Section S2). A comparison of Fourier-transformed infrared (FTIR) spectra of imine and amide-linked COFs showed the disappearance of the characteristic imine bond stretch at 1622 cm⁻¹ and the emergence of a signal at 1666 cm⁻¹, which is consistent with the carbonyl stretch present in the newly formed amide linkage (Section S3). A successful and complete linkage transformation was confirmed by solid-state nuclear magnetic resonance (NMR) spectroscopy of ¹³C-isotope enriched COFs in which the isotopically enriched carbon was positioned within the imine and amide linkages (Section S4). Scanning electron microscopy (SEM) characterization showed COF crystallites with an average size of 300 to 400 nm (Section S5) and thermogravimetric analysis (TGA) confirmed their thermal stability at processing temperatures of at least 300° C. (Section S6).

### Formation of Polymer-COF Junctions in PMMA-COF Composites

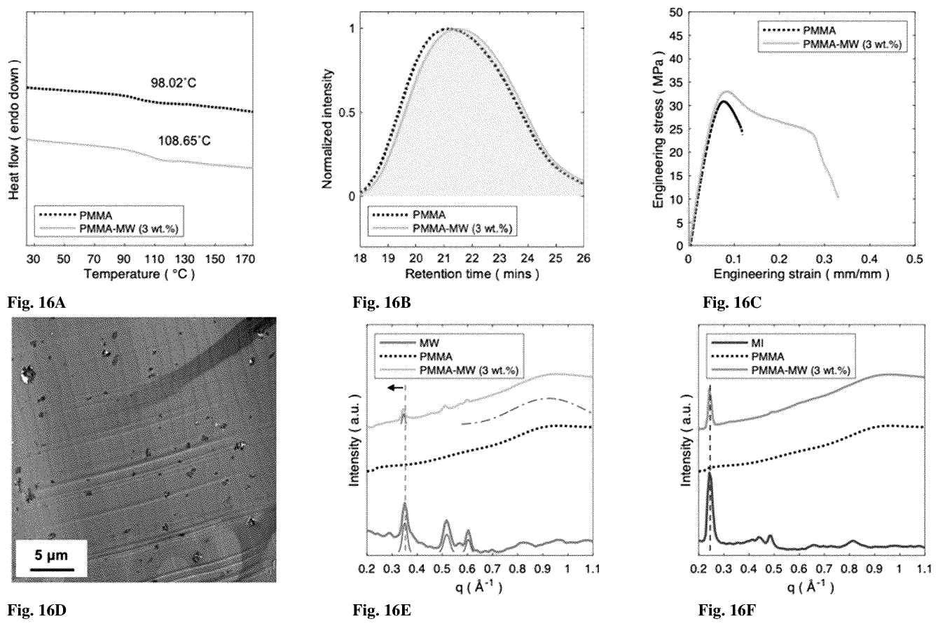

Amorphous, polymethyl methacrylate (PMMA) is very brittle with a failure strain of ˜0.13 mm/mm. PMMA was chosen to test if polymer-COF junctions can form when the polymer and COF nanocrystals have different chemical functionalities and if PMMA-COF junctions can enhance ductility. MW nanocrystals (3 wt. %) were introduced to PMMA (molecular weight (Mₙ)=535.5 kDa, polydispersity index (PDI)=2.50) via solution-mixing. Transmission electron microscopy (TEM) imaging confirmed that the MW nanocrystals were well dispersed in the PMMA matrix (FIG. 16A). The PMMA-MW composites were characterized using wide-angle X-ray scattering (WAXS) to investigate the crystal structure of the embedded COF nanocrystals (FIG. 16B). When compared to the characteristic diffraction peaks for the pristine MW, the peaks from the MW COF crystals embedded in PMMA shifted to slightly lower q values. When similar studies were carried out for PMMA-MI (3 wt. %), the peak positions remain the same for the pristine MI and PMMA-MI (FIG. 16C). In addition, the scattering intensity of diffraction peaks from a MW nanocrystal was significantly lower than what was observed when a MI nanocrystal was added in PMMA. This suggests that the PMMA chains may penetrate the pores of the woven COF, thereby expanding the unit cell of the woven COF crystals. Considering that the MW and MI are chemically identical, the reduced scattering intensity is consistent with polymer strands filling the pores to reduce the contrast in electron density from COF to air vs. COF to polymer. In differential scanning calorimetry (DSC) studies, there is a ˜10° C. increase in the glass transition temperature (T_{g}) for PMMA when 3 wt. % of MW nanocrystals were blended in (FIG. 16D). The DSC curves show only one transition, confirming the rather uniform phase behavior of PMMA within the detection resolution of the DSC technique. Once threaded through the COF crystals, PMMA chains can be fully or partially intercalated with MW. The uniform T_{g} transition suggests a long-range effect of the PMMA-COF junction beyond the COF crystal/PMMA interfaces. Nevertheless, the substantial increase in T_{g} is consistent with the scattering results and further supports the PMMA-COF junction formation. We measured the molecular weight of PMMA after dissolving the PMMA-MW composites and filtering out MW nanocrystals (FIG. 16E). Gel permeation chromatography (GPC) spectra showed a slight reduction in the molecular weight of PMMA from 535.5 kDa (PDI=2.50) to 433.2 kDa (PDI=2.62). Despite the small changes and the high PDI of the PMMA matrices, the results are rather consistent among different runs (n=3). Thus, higher molecular weight PMMA chains are more prone to form the PMMA-MW junctions and get removed from the solution after the filtration of MW nanocrystals.

Uniaxial mechanical tensile tests at ambient temperature showed the fracture strain of the PMMA-MW composites (3 wt. %) was increased from 0.13 (+0.02) mm/mm to 0.22 (+0.04) mm/mm (n=5). The toughness, determined by the area under the engineering stress-strain curves, nearly doubled from 2.6 (+0.5) MPa in the pure PMMA to 5.6 (+1.4) MPa in PMMA-MW (3 wt. %). We performed additional fracture tests using double-notch specimens, which consist of rectangular films containing two nominally identical notches, to characterize critical events prior to the onset of final failure (28, 29). As both notches experience the same stress and displacement fields, when one notch fractures, the unfractured notch is at the point of fracture and thus displays the precursor events just before unstable fracture. Scanned electron microscopy (SEM) images showed that the fracture surfaces in PMMA-MW exhibited a high roughness, with formations of nanofibers bridging the cracks (FIG. 16G). The dimensions of the fibers were measured to be 1.5 (±0.9) μm in length (n>10 samples) and 0.3 (±0.1) μm in diameter, i.e., with an aspect ratio (1) of 5.35 (±3.97). This measured A is higher than commonly reported values for glassy polymers, such as PMMA (×˜2.55) (30). The observed high-aspect-ratio nanofibrils suggest that PMMA can be stretched and aligned more readily to dissipate energy under stress. These results support the hypothesis that PMMA-MW junctions can form, and PMMA chains can be unthreaded from the MW nanocrystals.

### The Mechanical Properties of PI-COF Composites Enhanced by Polymer-COF Junctions

A liquid crystalline polymer, polyimide (PI) was also used to prepare composites. As PI has been well-engineered due to its industrial importance, our objective here was to evaluate if the polymer-COF junctions approach is technologically relevant and competitive for this material. The PI-COF composites were synthesized by in situ polymerizing pyromellitic dianhydride (PMDA) and 4,4′-oxydianiline (ODA) in a blend of COF crystallites (Section S1). The process is different from solution mixing used for PMMA-MW composite and is intended to whether polymer-COF junctions could be formed if chain growth occurs inside the COF.

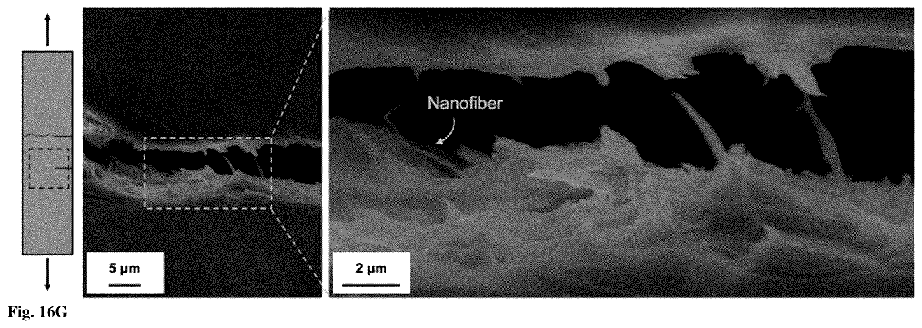

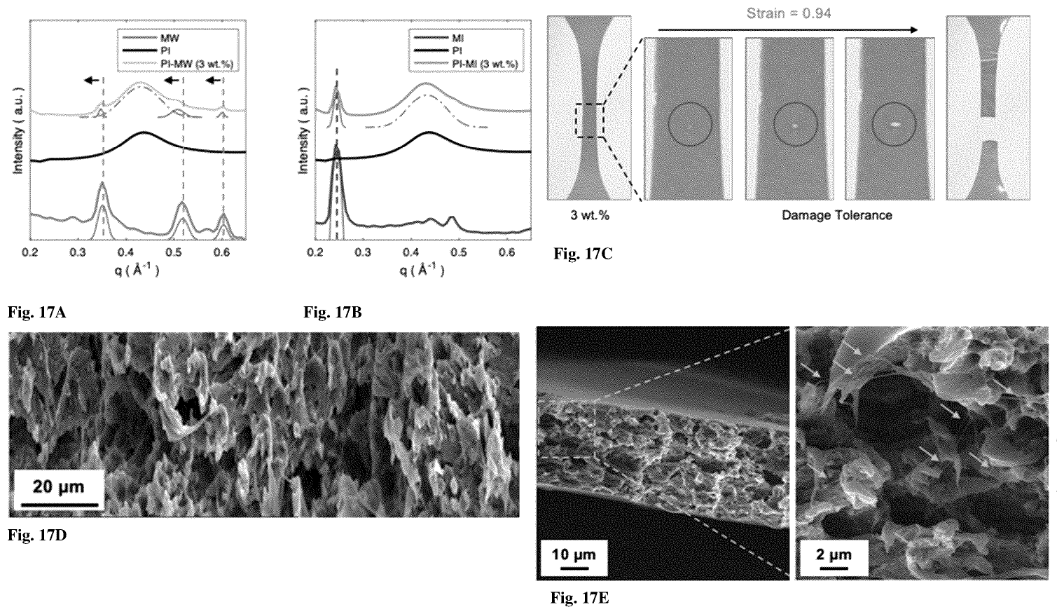

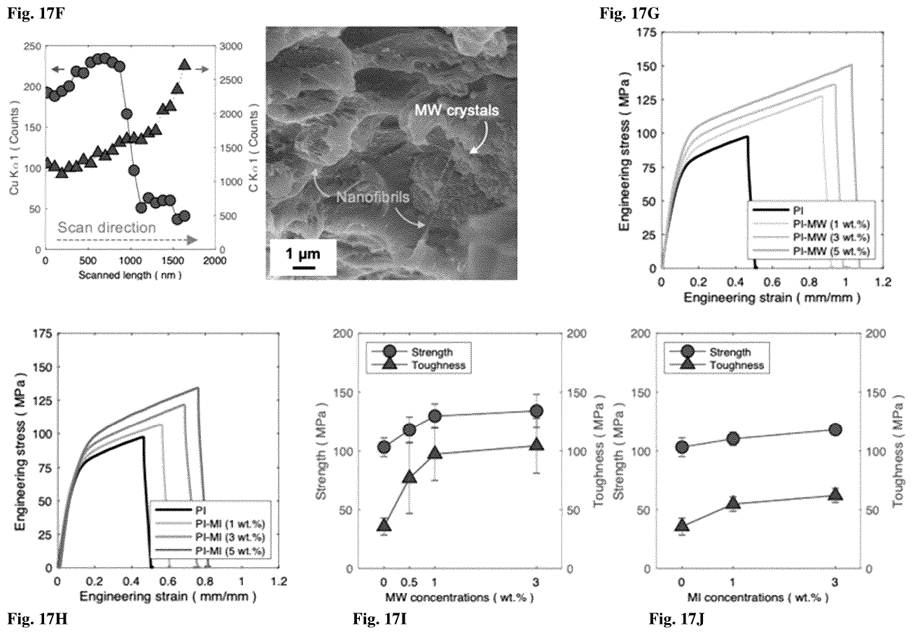

The uptake of the monomers was investigated by monomer inclusion studies (Section S8). Both MW and MI were soaked in a solution of the molecule of interest, e.g., PMDA or ODA, followed by extensive washing steps to eliminate any excess monomers outside of the pores. The amount of monomer inside the pores of the COFs was quantified by digest NMR spectroscopy, in which the COF material is broken down into its building blocks by acid digestion before NMR analysis. The digest NMR spectra of the soaked and subsequently washed COFs showed signals that were consistent with the monomers within the pores, further substantiating that the monomers can be diffused into the pores of MW and MI. To probe the molecular interactions between COFs and PI chains, the PI-COF composites were characterized by WAXS (FIG. 17-A B). The original scattering peaks from PI-MW (3 wt. %) were deconvoluted and then compared to pristine MW because the characteristic peaks of MW were sitting on the slope of the scattering peak from PI. WAXS results of PI-MW showed a slight unit cell expansion of MW and a reduction in intensity compared to PI-MI (3 wt. %). This is consistent with the findings for the PMMA-MW composites. Given that the MI and MW are chemically similar, the observed differences cannot be attributed to intermolecular interactions between the polymer and COFs. Rather, the result confirmed the feasibility to form polymer-COF junctions to maximize polymer conformational entropy in polymer/COF blends.

Compared to pure PI, the PI-COF composites exhibit improved macroscopic mechanical properties, including strength, ductility, toughness, and damage tolerance. The tensile tests on PI-MW showed enhanced fracture resistance even in the presence of a stress raiser in form of surface imperfections, which is in marked contrast to the catastrophic ruptures observed in pure PI (FIG. 17C). SEM fractography showed that the cross-sections of the PI-MW samples have a significantly higher surface roughness than the pure PI (FIG. 17D and Section S5). Over hundreds of micrometer length scales, the PI-MW showed a homogeneous fracture surface roughness with no interface-initiated cavitation. In addition, the higher-magnification SEM images displayed highly anisotropic nanofibers (FIG. 17E). To investigate the chemical compositions of the observed nanofibrils, SEM energy-dispersive X-ray spectroscopy (SEM-EDS) was performed. As shown in FIG. 17F, the fibrils are observed to gradually transition from a combination of COF and PI to pure PI, as verified by a decrease in the copper content (wt. %) from the origin of the craze fibrils to their tips. This supports the notion of an in situ formation of nanofibrils by unthreading the penetrated polymer strands that are spatially arranged via the nanometer-level periodicity of the COF nanocrystals.

In addition, the incorporation of 0.5-1 wt. % of MW results in a drastic increase in these properties (FIG. 171), whereas their property enhancement correlates linearly with the increase in MI concentration from 0 to 3 wt. % (FIG. 17J). This suggests that the percolation threshold corresponds to substantially lower filler ratios (˜1 wt. %) in PI-MW than in PI-MI. At this concentration, the interparticle distances of PI-MW were measured to be ˜1.7 (±1.2) μm by TEM analysis (Section S9). Collectively, these observations demonstrated that the effect of the polymer-COF junction extends beyond the range of filler/matrix interfaces, which are typically limited to tens of nanometers (31).

To characterize the fiber formation capability by polymer unthreading in response to mechanical force, further WAXS studies were performed on the plastically deformed PI-COF films (Section S10). The stretching process orients the composite in the force direction without affecting the structure of the COF crystals. Azimuthal integration at q=0.439 Å⁻¹, which represents the intramolecular spacing of neat PI (32), was conducted to show the orientation of the polymer chains in each system. The PI-COF composites (3 wt. %) showed a higher orientational order parameter (P̅₂̅), which is estimated from the Azimuthal integration (33), as is indicated by the increased intensity variation. Specifically, the PI-MW exhibited a higher (P̅₂̅)=0.72-0.83 (1-3 wt. %), than the PI (0.39) and PI-MI (3 wt. %) (0.42). This corresponds to a detailed comparison of the macroscopic mechanical properties of PI-MW and PI-MI revealing that MI enhanced the composite's properties less effectively than MW (FIG. 17G-H). Accordingly, we can conclude that the intramolecular distance of the PI chains is more uniform in PI-MW compared to PI and PI-MI, which further supports our polymer-COF junction hypothesis.

### The Importance of Framework Topology on the Formation of Polymer-COF Junctions

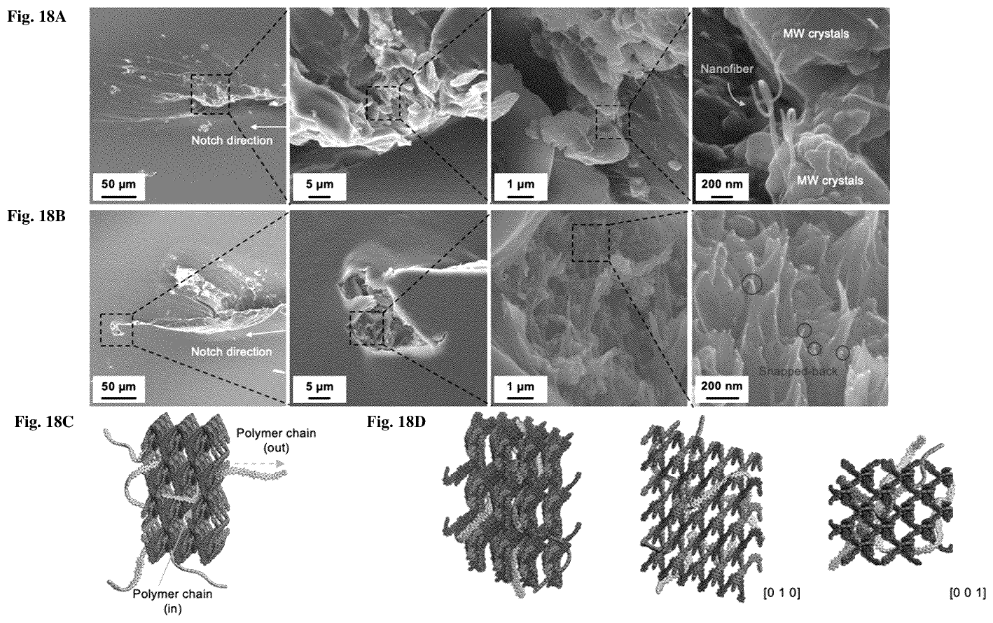

The morphology of unthreaded polymer fibers can be affected by the topology of COF nanocrystals. The enlarged SEM image from the double-notch experiments of PI-MW (3 wt. %) shows the gradual formation of high-aspect-ratio fibrils microstructures (×˜16.08 (+8.67), n>10 samples), which bridge the MW crystal agglomerates by unthreading (FIG. 18A). In contrast, the stretched PI-MI composites show shorter fibrils (×˜5.20 (+2.15), n>10 samples) that exhibit signs of snap-back behavior at the moment of mechanical failure, thereby resulting in spherical morphologies with diameters of ˜18 nm at the end of fibrils (FIG. 18B). The different structural characteristics of the nanofibrils formed in the PI-MW and PI-MI appear to result from the proposed threading and unthreading of polymer strands under stress.

To delineate the contribution of covalent bond formation between the polymer and the COFs, additional tensile tests were performed (Section S11). In these experiments, the PI-MW films were prepared by the physical blending of poly(amic acid) solutions with the COFs and by in situ polymerization using the surface-passivated COFs. In both experiments, reactions between the monomers and the surface functional groups of the COFs were eliminated (Section S12). The tensile test results show that the strength and toughness of the PI-MW composites were still effectively improved compared to pure PI films. This provides evidence that topological, non-covalent entanglements between the COF crystals and polymer matrix play a more significant role than covalent bonding in improving the mechanical properties in PI-MW composites.

Considering the identical chemical makeup of the backbones in MW and MI, the topology of the COF nanocrystals may be one of the key parameters to forming an effective entanglement network because the conformation of a polymer chain can be determined by its topological constraints. Based on the 90° angle in the pore structure and fewer spatial deviations of MI, we hypothesize that the polymer chains cannot effectively penetrate the COF far beyond its surface (FIG. 18C and Section S13). However, the topology of MW, which provides polymer chains with more possible pathways to thread through, would be more suitable for polymer chains to form polymer-COF junctions (FIG. 18D and Section S13).

The topological differences between MW and MI can be compared by measuring their mechanical rigidity. Thus, we performed nano dynamic mechanical analysis (nano DMA) by using nanoindentation to validate that less topological constraints of MW can induce more flexible mechanical behavior compared to MI (Section S14). Indeed, the nano DMA results showed that the MW nanocrystals (0.5-1.8 GPa) have a lower storage modulus distribution than the MI crystals (1.0-3.2 GPa). This indicates that MW can provide more effective constraints for polymer chains to diffuse because MW has higher spatial deviations and degrees of freedom than MI (15). However, when diffusing through the MI nanocrystals, the chains may show a preference to dangle at the filler surfaces that have shallower penetration depths due to the topological constraints imposed by mechanically rigid, interlocked organic frameworks.

Mechanical tests using demetalated woven (DMW) and interlocked (DMI) COFs served to further highlight the effects of the polymer-COF junctions. By removing Cu(I) copper ions, demetalation can be carried out to produce mutually woven and interlocked COF nanocrystals (Section S5), which are more mechanically flexible than their metalated counterparts. In the case of PI-DMI, the mechanical strength and toughness improved more effectively than in PI-MI (Section S11), displaying a unit cell expansion of DMI COF crystals by the absorbed polymers (Section S10). Therefore, we can conclude that the COF's topology is critical to determining the effective formation of polymer-COF junctions.

Polymer chain penetration is an entropically driven process. Chemically attractive interaction can be beneficial but is not a pre-requisite. As discussed, polymer chain conformation plays a much more significant role in forming polymer-COF junctions. Entropy-driven penetration was also observed for polymers with non-favorable chemical backbones, such as polystyrene (Section S11). Composites including porous but non-woven MOFs and COFs, such as COF-300, COF-791, MOF-808, and MIL-53, show less to no mechanical property enhancement (Table S1). In this case, the crystal structure determines the polymer conformation and torsion angle distribution. Only those maximizing the conformation entropy will result in a high penetration depth. Thus, we conclude that the 3D woven COF nanocrystals exhibit fundamentally different behavior, compared to other known filler materials, with the formation of polymer-COF junctions that can molecularly control the interfaces, threading, and entanglements and ultimately improve the macroscale material's properties.

### REFERENCES

1. S. F. Edwards, The statistical mechanics of polymerized material. Proceedings of the Physical Society 92, 9-16 (1967).
2. G. Allen, A. Charlesby, D. Tabor, G. N. Welding, The Molecular Basis of Rubber Elasticity [and Discussion]. Proceedings of the Royal Society of London. Series A, Mathematical and Physical Sciences 351, 381-396 (1976).
3. W. W. Graessley, D. S. Pearson, Stress-strain behavior in polymer networks containing nonlocalized junctions. The Journal of Chemical Physics 66, 3363-3370 (1977).
4. J. Kim, G. Zhang, M. Shi, Z. Suo, Fracture, fatigue, and friction of polymers in which entanglements greatly outnumber cross-links. Science 374, 212-216 (2021).
5. L. Brunsveld, B. J. B. Folmer, E. W. Meijer, R. P. Sijbesma, Supramolecular Polymers. Chemical Reviews 101, 4071-4098 (2001).
6. S. K. Kumar, N. Jouault, B. Benicewicz, T. Neely, Nanocomposites with Polymer Grafted Nanoparticles. Macromolecules 46, 3199-3214 (2013).
7. J. Choi et al., Effect of Polymer-Graft Modification on the Order Formation in Particle Assembly Structures. Langmuir 29, 6452-6459 (2013).
8. J. Xu et al., Highly stretchable polymer semiconductor films through the nanoconfinement effect. Science 355, 59-64 (2017).
9. S. Rose et al., Nanoparticle solutions as adhesives for gels and biological tissues. Nature 505, 382-385 (2014).
10. J. Choi et al., Toughening fragile matter: mechanical properties of particle solids assembled from polymer-grafted hybrid particles synthesized by ATRP. Soft Matter 8, 4072-4082 (2012).
11. P. G. De Gennes, in Tribology Series, J. M. Georges, Ed. (Elsevier, 1981), vol. 7, pp. 355-367.
12. Z. O. G. Schyns, M. P. Shaver, Mechanical Recycling of Packaging Plastics: A Review. Macromolecular Rapid Communications 42, 2000415 (2021).
13. P. G. de Gennes, Reptation of a Polymer Chain in the Presence of Fixed Obstacles. J. Chem. Phys 55, 572-579 (1971).
14. Y. Liu et al., 3D Covalent Organic Frameworks of Interlocking 1D Square Ribbons. Journal of the American Chemical Society 141, 677-683 (2019).
15. Y. Liu et al., Weaving of organic threads into a crystalline covalent organic framework. Science 351, 365 (2016).
16. Y. Liu et al., Molecular Weaving of Covalent Organic Frameworks for Adaptive Guest Inclusion. Journal of the American Chemical Society 140, 16015-16019 (2018).
17. T. Ma et al., Observation of Interpenetration Isomerism in Covalent Organic Frameworks. Journal of the American Chemical Society 140, 6763-6766 (2018).
18. H. L. Nguyen, C. Gropp, Y. Ma, C. Zhu, O. M. Yaghi, 3D Covalent Organic Frameworks Selectively Crystallized through Conformational Design. Journal of the American Chemical Society 142, 20335-20339 (2020).
19. J. Jiang et al., Superacidity in Sulfated Metal-Organic Framework-808. Journal of the American Chemical Society 136, 12844-12847 (2014).
20. T. Loiseau et al., A Rationale for the Large Breathing of the Porous Aluminum Terephthalate (MIL-53) Upon Hydration. Chemistry A European Journal 10, 1373-1382 (2004).
21. B. Lee, Z. Niu, S. L. Craig, The Mechanical Strength of a Mechanical Bond: Sonochemical Polymer Mechanochemistry of Poly(catenane) Copolymers. Angewandte Chemie International Edition 55, 13086-13089 (2016).
22. M. Zhang, G. De Bo, A Catenane as a Mechanical Protecting Group. Journal of the American Chemical Society 142, 5029-5033 (2020).
23. M. Zhang, G. De Bo, Mechanical Susceptibility of a Rotaxane. Journal of the American Chemical Society 141, 15879-15883 (2019).
24. C. S. Diercks, O. M. Yaghi, The atom, the molecule, and the covalent organic framework. Science 355, caal1585 (2017).
25. P. J. Waller, F. Gándara, O. M. Yaghi, Chemistry of Covalent Organic Frameworks. Accounts of Chemical Research 48, 3053-3063 (2015).
26. F. Haase, B. V. Lotsch, Solving the COF trilemma: towards crystalline, stable and functional covalent organic frameworks. Chemical Society Reviews 49, 8469-8500 (2020).
27. P. J. Waller et al., Chemical Conversion of Linkages in Covalent Organic Frameworks. Journal of the American Chemical Society 138, 15519-15522 (2016).
28. P. Novak, R. Yuan, B. P. Somerday, P. Sofronis, R. O. Ritchie, A statistical, physical-based, micro-mechanical model of hydrogen-induced intergranular fracture in steel. Journal of the Mechanics and Physics of Solids 58, 206-226 (2010).
29. R. K. Nalla, J. H. Kinney, R. O. Ritchie, Mechanistic fracture criteria for the failure of human cortical bone. Nat. Mater. 2, 164-168 (2003).
30. A. S. Argon, M. Salama, The mechanism of fracture in glassy materials capable of some inclastic deformation. Materials Science and Engineering 23, 219-230 (1976).
31. H. K. Nguyen, K. Nakajima, Evidence of the Transition from a Flexible to Rigid Percolating Network in Polymer Nanocomposites. Macromolecules, (2022).
32. J.-H. Jou, P.-T. Huang, X-Ray Diffraction Study of Polyimide Blends Compatibility. Polym. J. 22, 909-918 (1990).
33. G. Weng, G. Huang, L. Qu, Y. Nie, J. Wu, Large-Scale Orientation in a Vulcanized Stretched Natural Rubber Network: Proved by In Situ Synchrotron X-ray Diffraction Characterization. The Journal of Physical Chemistry B 114, 7179-7188 (2010).
34. F. Gallou et al., A practical non-cryogenic process for the selective functionalization of bromoaryls. Tetrahedron Letters 49, 5024-5027 (2008).

### Section S1.Synthetic Procedures

Starting materials for the synthesis of woven Cu-COF-506 and interlocked Cu-COF-500:

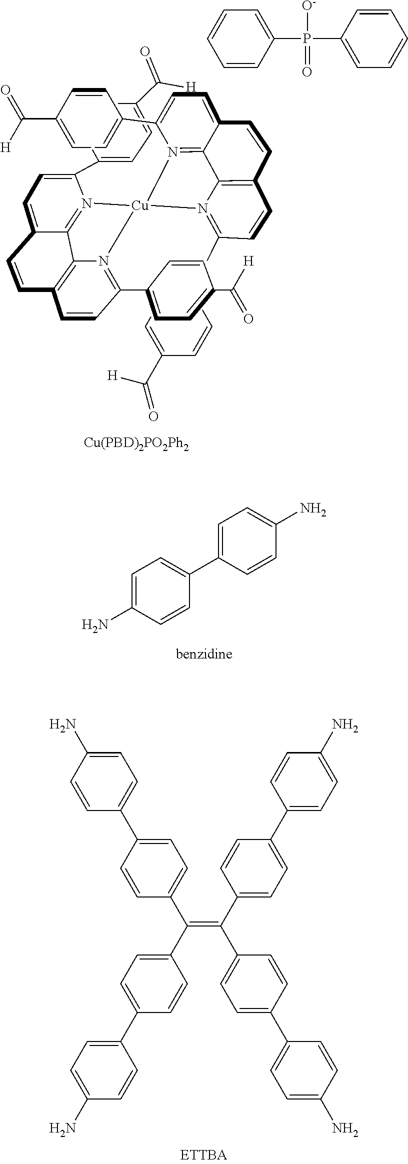

### Synthesis of ETTBA:

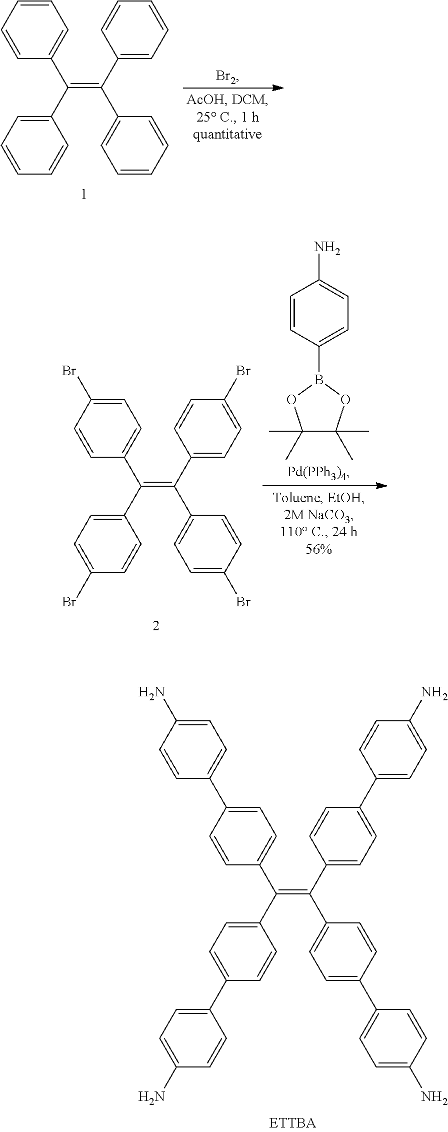

Synthesis of Cu(PDB)₂PO₂Ph₂:

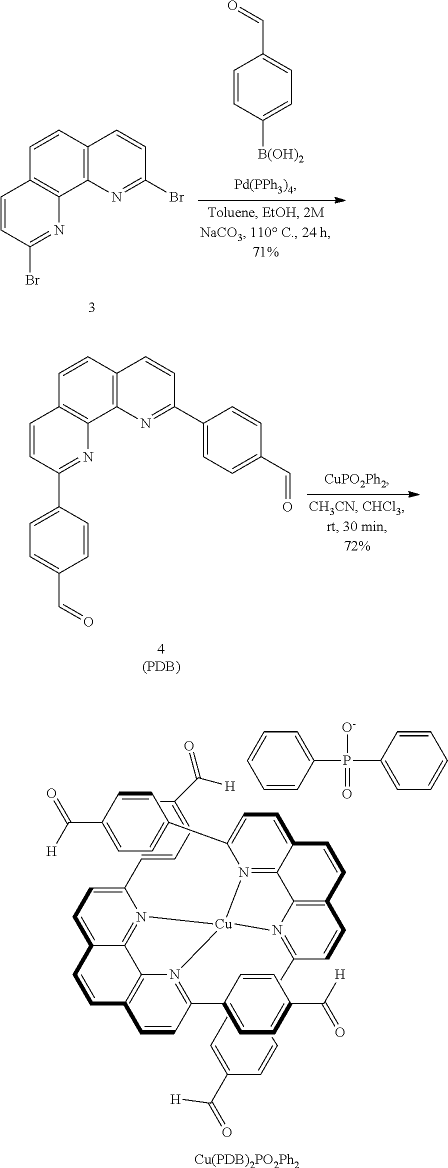

### 4′,4′″,4′″″,4″″″-(ethene-1,1,2,2-tetrayl)tetrakis(([1,1′-biphenyl]-4-amine)) (ETTBA)

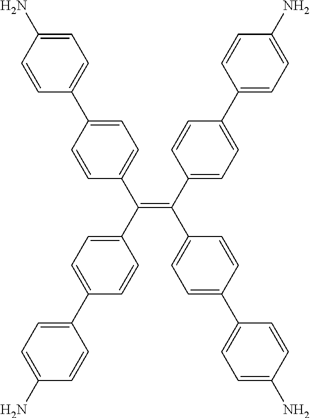 [SMILES: Nc1ccc(-c2ccc(C(=C(c3ccc(-c4ccc(N)cc4)cc3)c3ccc(-c4ccc(N)cc4)cc3)c3ccc(-c4ccc(N)cc4)cc3)cc2)cc1]

ETTBA was synthesized following a previously reported procedure (14). In a 250 mL round bottom flask, 2 (2.00 g, 3 mmol) and (4-aminophenyl) boronic acid pinacol ester (4.7 g, 21 mmol) were suspended in a mixture of toluene (160 mL), ethanol (15 mL), and an aqueous solution of 2M Na₂CO₃ (7 mL). The solution was purged with nitrogen for 2 h before Pd(PPh₃)₄ (347 mg, 0.3 mmol) was added. The resulting mixture was transferred to an oil bath preheated to 110° C. and stirred vigorously for 24 h. After cooling to room temperature, the organic layer was isolated, and the aqueous layer extracted with dichloromethane (2×40 mL). The organic layers were combined, dried over Na₂SO₄, filtered, and evaporated in vacuo to provide a yellow/brown solid. The product was further purified by flash silica gel chromatography with dichloromethane to 1:100 (v/v) of methanol and dichloromethane. Evaporation of the solvent in vacuo afforded 3 as a bright yellow powder (1.2 g, 56%).

¹H NMR (400 MHZ, DMSO-d₆) δ 7.35 (d, J=8.2 Hz, 2H), 7.32 (d, J=8.4 Hz, 2H), 7.01 (d, J=8.2 Hz, 2H), 6.58 (d, J=8.4 Hz, 2H), 5.21 (s, 2H). ¹³C NMR (151 MHZ, DMSO-d₆) δ 148.32, 141.06, 139.43, 138.34, 131.37, 126.88, 126.58, 124.40, 114.19. HR-MS (ESI), calcd. for [C₅₀H₄₁N₄]⁺, [M+H]⁺, 697.3326, found 697.3318.

### Cu(PDB)₂PO₂Ph₂ [PDB=4,4′-(1,10-phenanthroline-2,9-diyl)dibenzaldehyde]

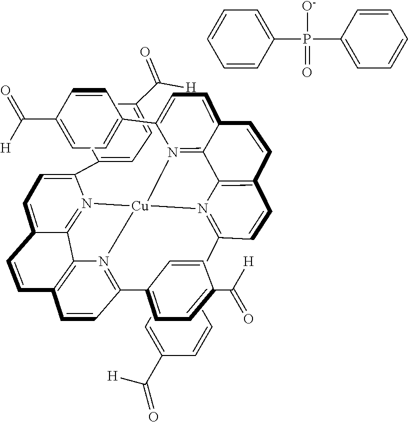

Cu(PDB)₂PO₂Ph₂ was synthesized following a previously reported procedure (16). Copper (I) diphenylphosphinate (199 mg, 0.71 mmol) was added to a solution of 4 (500 mg, 1.29 mmol) in chloroform (15 mL) and acetonitrile (10 mL) in the glovebox, affording a dark red solution, which was stirred at room temperature for 30 min. The solution was then concentrated under vacuum and further purified by column chromatography with a gradient of solvent from a 1:100 (v/v) to 1:10 (v/v) mixture of methanol to dichloromethane. Recrystallization from acetone afforded the analytically pure compound as red crystals (489.9 mg, 72%).

1H NMR (400 MHZ, DMSO-d₆) δ 9.68 (s, 4H), 8.83 (d, J=7.9 Hz, 4H), 8.19 (d, J=7.9 Hz, 4H), 8.15 (s, 4H), 7.72 (m, 4H), 7.62 (d, J=8.0 Hz, 8H), 7.43 (m, 6H), 7.07 (d, J=8.0 Hz 8H). HR-MS (ESI), calcd. for [C₅₂H₃₂CuN₄O₄]⁺, [M]⁺, 839.17, found 839.17.

### Synthesis of ¹³C-labeled Cu(PDB)₂PO₂Ph₂

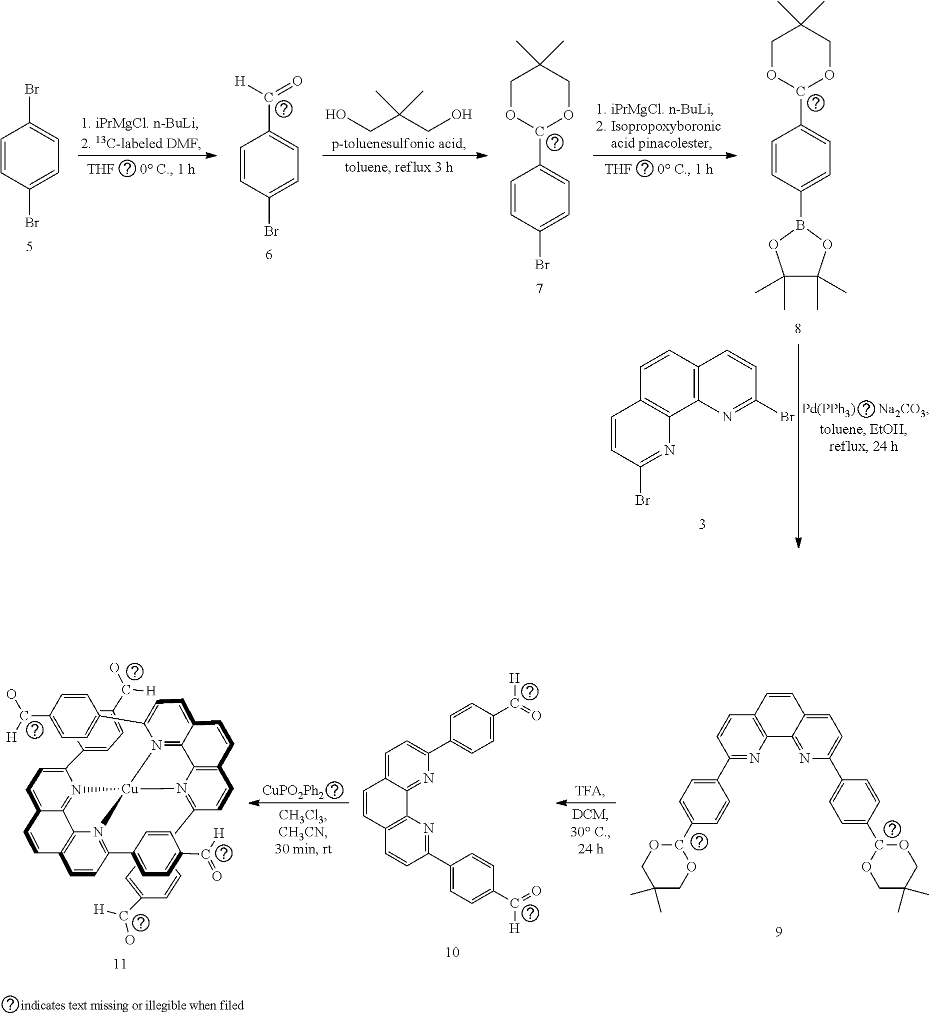

### ¹³C-labeled 4-bromobenzaldehyde (6)

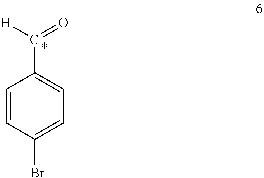

¹³C-labeled 4-bromobenzaldehyde was synthesized following a previously reported procedure (34). To a solution of 5 (2.83 g, 12 mmol) in dry THF (12 mL) at 0° C. was added a 1.3 M solution of iPrMgCl in THF (3.4 mL, 4.44 mmol) in 5 min. The clear solution was stirred at 0° C. for an additional 10 min, and a 1.6 M solution of nBuLi in hexanes (5.55 mL, 8.88 mmol) was added in 10 min, while maintaining the temperature below 5° C. The resulting mixture was stirred at that temperature for 1 h, cooled to −10° C., and N,N-dimethylformamide-(carbonyl-¹³C) (1 mL, 12.96 mmol) in dry THF (13 mL) was added dropwise in 10 min. The resulting mixture was warmed to rt in 1 h and added to a 0.5 M citric acid solution. After stirring for 10 min, the phases were separated, and the aqueous phase was extracted with toluene (2×15 mL). The organic phases were combined, dried over Na₂SO₄, followed by evaporation of the solvent to obtain 6 as a colorless powder (2.07 g, 93%).

1H NMR (400 MHZ, CDCl₃) δ 9.98 (d, J=175.4 Hz, 1H), 7.79-7.66 (m, 4H). ¹³C NMR (151 MHz, CDCl₃) δ 191.22, 135.20, 132.60, 131.12, 129.94. HR-MS (ESI), calcd. for [¹²C₆¹³CH₄OBr]⁺, [M+H]⁺, 183.9479, found 183.9484.

### ¹³C-labeled 2-(4-bromophenyl)-5,5-dimethyl-1,3-dioxane (7)

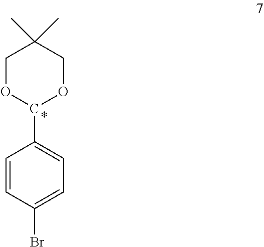

To a solution of 6 (2.07 g, 11.2 mmol) in toluene (25 mL) were added neopentyl glycol (1.4 g, 13.4 mmol) and p-toluenesulfonic acid monohydrate (59 mg, 0.3 mmol). The resulting mixture was heated to 110° C. under stirring for 3 h. After cooling to room temperature, the solution was extracted with saturated aqueous solution of NaHCO₃ and dried over Na₂SO₄. Evaporation of the solvent afforded 7 as a colorless powder (3.06 g, 100%).

1H NMR (400 MHZ, CDCl₃) δ 7.53-7.35 (m, 4H), 5.35 (d, J=177.4 Hz, 1H), 3.76 (ddt, J=10.9, 7.8, 1.5 Hz, 2H), 3.64 (d, J=10.8 Hz, 2H), 1.28 (s, 3H), 0.80 (s, 3H). ¹³C NMR (151 MHz, CDCl₃) δ 137.68, 131.55, 128.05, 123.01, 101.07, 30.36, 23.15, 21.99. HR-MS (ESI), calcd. for [¹²C₁₁¹³CH₁₄O₂Br]⁺, [M+H]⁺, 270.0211, found 270.0210.

### ¹³C-labeled 2-(4-(5,5-dimethyl-1,3-dioxan-2-yl)phenyl)-4,4,5,5-tetramethyl-1,3,2-dioxaborolane (8)

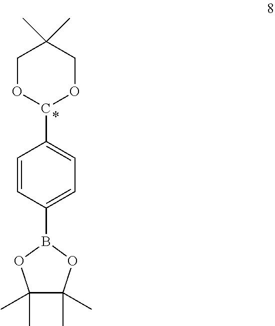

To a solution of 7 (3.06 g, 11.3 mmol) in dry THF (25 mL) at 0° C. was added a 1.3 M solution of iPrMgCl in THF (3.2 mL, 4.2 mmol) in 5 min. The clear solution was stirred at 0° C. for an additional 10 min, and a 1.6 M solution of nBuLi in hexanes (5.2 mL, 8.4 mmol) was added in 10 min, while maintaining the temperature below 5° C. The resulting mixture was stirred at that temperature for 1 h, cooled to −10° C., and 2-isopropoxy-4,4,5,5-tetramethyl-1,3,2-dioxaborolane (2.27 g, 12.2 mmol) in dry THF (13 mL) was added dropwise in 10 min. The resulting mixture was warmed to rt in 1 h and added to a 0.5 M citric acid solution. After stirring for 10 min, the phases were separated, and the aqueous phase was extracted with toluene (2×15 mL). The organic phases were combined, dried over Na₂SO₄, followed by evaporation of the solvent. The product was further purified by flash silica gel chromatography with 30:100 (v/v) of ethyl acetate in hexanes. Evaporation of the solvent in vacuo afforded 8 as a colorless powder (1.98 g, 55%).

1H NMR (400 MHZ, CDCl₃) δ 7.81 (d, J=7.7 Hz, 2H), 7.50 (dd, J=7.9, 4.1 Hz, 2H), 5.39 (d, J=168.1 Hz, 1H), 3.81-3.73 (m, 2H), 3.64 (d, J=10.8 Hz, 2H), 1.34 (s, 12H), 1.29 (s, 3H), 0.80 (s, 3H). ¹³C NMR (151 MHZ, CDCl₃) δ 141.40, 134.94, 125.55, 101.76, 83.93, 73.61, 30.42, 25.00, 23.21, 22.05. HR-MS (ESI), calcd. for [¹²C₁₇¹³CH₂₆O₄B]⁺, [M+H]⁺, 317.1994, found 317.1996.

### ¹³C-labeled 2,9-bis(4-(5,5-dimethyl-1,3-dioxan-2-yl)phenyl)-1,10-phenanthroline (9)

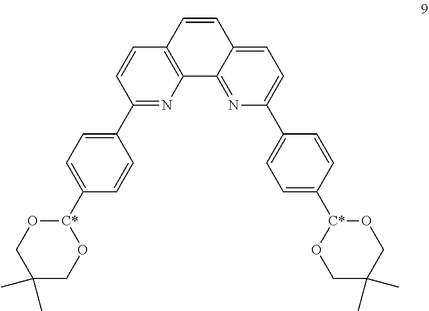

In a 250 mL round bottom flask, 3 (680 mg, 2 mmol) and 8 (1.92 g, 6 mmol) were suspended in a mixture of toluene (70 mL), ethanol (7 mL), and an aqueous solution of 2M Na₂CO₃ (7 mL). The solution was purged with nitrogen for 2 h before Pd(PPh₃)₄ (231 mg, 0.2 mmol) was added. The resulting mixture was transferred to an oil bath preheated to 110° C. and stirred vigorously for 24 h. After cooling to room temperature, the brownish precipitate was collected, and recrystallized in a mixture of CHCL₃ and EtOH to afford 9 as an off-white powder (515 mg, 46%).

1H NMR (400 MHZ, CDCl₃) δ 8.52-8.47 (m, 4H), 8.30 (d, J=8.4 Hz, 2H), 8.15 (d, J=8.4 Hz, 2H), 7.76-7.70 (m, 4H), 5.51 (d, J=171.4 Hz, 1H), 3.83 (ddt J=10.9, 7.8, 1.4 Hz, 4H), 3.64 (d, J=10.8 Hz, 2H), 3.75-3.68 (m, 4H), 1.35 (s, 6H), 0.84 (s, 6H). ¹³C NMR (151 MHZ, CDCl₃) δ 156.54, 146.27, 139.97, 139.49, 137.01, 128.12, 127.74, 126.79, 126.18, 120.14, 101.75, 30.48, 23.29, 22.10. HR-MS (ESI), calcd. for [¹²C₃₄¹³C₂H₃₇O₄N₂]⁺, [M+H]⁺, 563.2815, found 563.2805.

¹³C-labeled 4,4′-(1,10-phenanthroline-2,9-diyl)dibenzaldehyde (10)

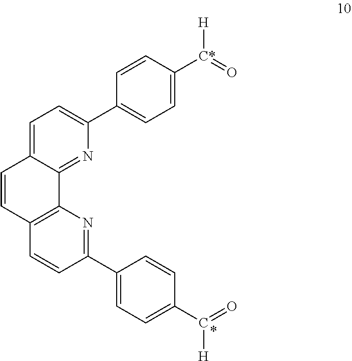

To a solution of 9 (515 mg, 0.9 mmol) in dichloromethane (50 mL) was added trifluoroacetic acid (6.9 mL, 0.09 mmol). The resulting solution was stirred under reflux for 24 h. After cooling to room temperature, an aqueous solution of NaOH (6M) was added to neutralize the solution. The organic layer was separated and extracted with H₂O and brine before drying over Na₂SO₄. Evaporation of the solvent afforded 10 as an off-white powder (330 mg, 94%).

1H NMR (400 MHZ, CDCl₃) 10.15 (d, J=190.6 Hz, 2H), 8.62 (d, J=8.0 Hz, 4H), 8.39 (d, J=8.4 Hz, 2H), 8.23 (d, J=8.3 Hz, 2H), 8.12 (dd, J=8.2, 4.7 Hz, 4H), 7.87 (s, 2H). ¹³C NMR (151 MHz, CDCl₃) § 192.23, 168.45, 155.60, 146.34, 145.00, 137.46, 130.46, 128.66, 128.37, 126.86, 120.78. HR-MS (ESI), calcd. for [¹²C₂₄¹³C₂H₁₇O₂N₂]⁺, [M+H]⁺, 391.1352, found 391.1352.

### ¹³C-labeled Cu(PDB)₂PO₂Ph₂ (11)

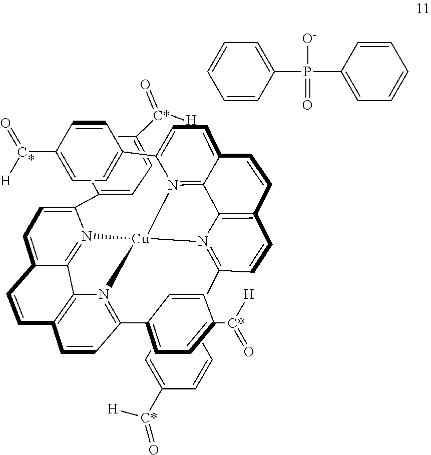

Copper (I) diphenylphosphinate (101 mg, 0.36 mmol) was added to a solution of 10 (249 mg, 0.64 mmol) in chloroform (7.5 mL) and acetonitrile (5 mL) in the glovebox, affording a dark red solution, which was stirred at room temperature for 30 min. The solution was then concentrated under vacuum and further purified by column chromatography with a gradient of solvent from a 1:100 (v/v) to 1:10 (v/v) mixture of methanol to dichloromethane. Recrystallization from acetone afforded the compound as red crystals (312 mg, 92%).

1H NMR (400 MHZ, DMSO-d₆) 9.68 (d, J=191.6 Hz, 4H), 8.83 (d, J=8.3 Hz, 4H), 8.18 (d, J=8.2 Hz, 4H), 8.15 (s, 4H), 7.62 (d, J=7.8 Hz, 8H), 7.22 (s, 6H), 7.07 (dd, J=7.9, 4.6 Hz, 6H). HR-MS (ESI), calcd. for [¹²C₄₈¹³C₄H₃₂O₄N₄Cu]⁺, [M+H]⁺, 843.1848, found 843.1832.

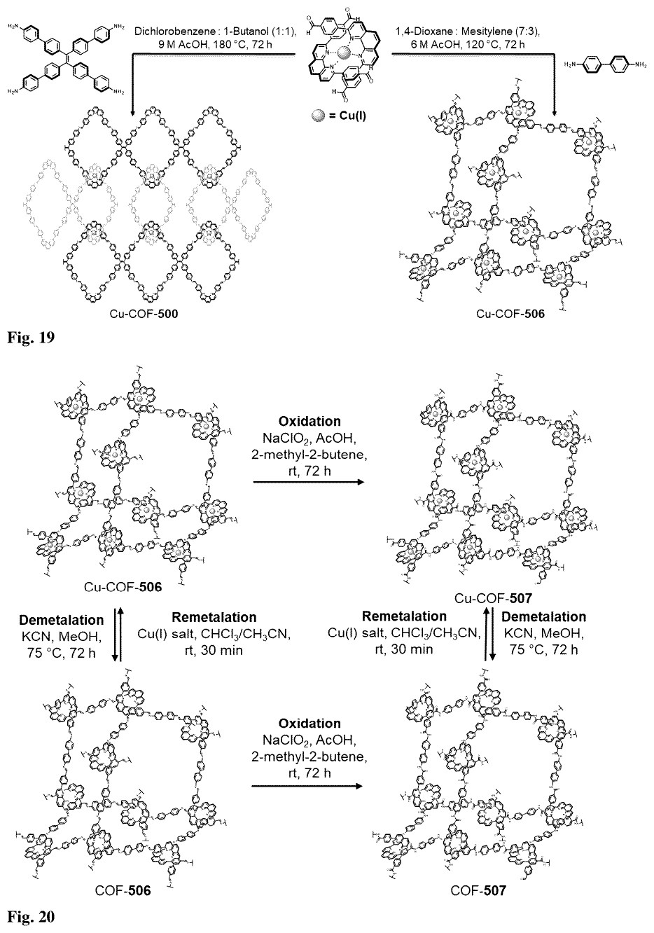

### Synthesis of Woven Cu-COF-506 and Interlocked Cu-COF-500: FIG. 19

Synthesis of Cu-COF-506. Cu-COF-506 was synthesized following a previously reported procedure (16). A Pyrex tube measuring 10×8 mm (o.d.×i.d.) was charged with Cu(PDB)₂PO₂Ph₂ (17.6 mg, 0.016 mmol), benzidine (6 mg, 0.032 mmol), anhydrous 1,4-dioxane (0.7 mL), mesitylene (0.3 mL), and 0.1 mL of 6 M aqueous acetic acid. The tube was flash frozen at 77 K (liquid N₂ bath), evacuated under dynamic vacuum to an internal pressure of 50 mTorr, and flame sealed. Upon sealing, the length of the tube was reduced to 18-20 cm. The reaction was heated at 120° C. for 72 h yielding a brown solid at the bottom of the tube which was isolated by centrifugation and washed with THF in a Soxhlet extractor for 24 h to give Cu-COF-506 with PO₂Ph₂-counter anions. The resulting powder is insoluble in water and common organic solvents such as hexanes, methanol, acetone, THF, N,N-dimethylformamide, and dimethyl sulfoxide, indicating the formation of an extended structure. Yield: 18.4 mg, 81.7% based on Cu(PDB)₂PO₂Ph₂.

Elemental analysis for C₈₈H₅₆CuN₈O₂P·6H₂O: Calcd. C, 72.39; H, 4.69; N, 7.67%. Found: C, 72.44; H, 4.54; N, 7.59%. ICP-AES of Cu content: calcd. 4.07%; found 3.9%.

Synthesis of Cu-COF-500: Cu-COF-500 was synthesized following a previously reported procedure (14). A Pyrex tube measuring 10×8 mm (o.d×i.d) was charged with Cu(PDB)₂PO₂Ph₂ (17.6 mg, 0.0160 mmol), ETTBA (12.0 mg, 0.0160 mmol), 0.5 mL of 1,2-dichlorobenzene, 0.5 mL of 1-butanol, and 0.1 mL of 9 M aqueous acetic acid. The tube was flash frozen at 77 K (liquid N₂), evacuated to an internal pressure of 50 mTorr, and flame-scaled. Upon scaling, the length of the tube was reduced to 18-20 cm. The reaction was heated at 180° C. for 72 h, yielding a brown solid at the bottom of the tube, which was isolated by centrifugation and washed by Soxhlet extraction with anhydrous tetrahydrofuran (THF) for 12 h. The sample was activated at 85° C. under reduced pressure (50 mTorr) for 12 h. Yield: 21.2 mg, 75.7% based on Cu(PDB)₂PO₂Ph₂.

Elemental analysis for C₁₁₄H₇₄CuN₈O₂P·6H₂O: Calcd. C, 76.47; H, 4.84; N, 6.25. Found: C, 75.75; H, 4.99; N, 6.14. ICP-AES of Cu content: calcd. 3.55%; found 3.5%.

### Synthesis of Amide-Linked Cu-COF-501 (MI) and Cu-COF-507 (MW) (Linkage Conversion); FIG. 20

Post-synthetic linkage conversion from imine to amide was performed by following an optimized procedure from a previous report (27). To a suspension of Cu-COF-500 (100 mg, 0.22 mmol by imine) in dioxane (10 mL) was added 2-methyl-2-butene (2.4 mL, 22 mmol, 100 equiv), aqueous sodium chlorite solution (410 μL, 3 M, 1.23 mmol, 5.5 equiv), and glacial acetic acid (131 μL, 2.2 mmol, 10 equiv) in sequence. The biphasic suspension was stirred at room temperature in the dark for 24 h, after which an additional portion of sodium chlorite solution (410 μL, 3 M, 1.23 mmol, 5.5 equiv) was added. This was repeated for 5 days, after which amide-linked Cu-COF-501 was isolated by filtration and washed with water (10 mL), then 10% sodium thiosulfate (10 mL), then water (10 mL) and finally acetone (10 mL). The material was activated by Soxhlet extraction with dioxane, methanol, and acetone in sequence, each for 24 h, and then activated under dynamic vacuum at room temperature for 16 h followed by dynamic vacuum at 120° C. for 2 h.

Amide-linked Cu-COF-507 was synthesized in an analogous method, with reagent loading scaled to equivalences of the imine bond.

Demetalation of COFs. To a suspension of the metalated COF powder was added a 0.3 M KCN solution in MeOH, and was heated to 75° C. The solution was replaced by a fresh solution of KCN every 24 h and this procedure was repeated three times. Subsequently, the sample was washed with anhydrous MeOH and water, followed by drying at 120° C. under 50 mTorr for 12 h. The demetalated material was observed to be pale-yellow in color, in contrast to the dark brown color of both Cu-COF-501 and Cu-COF-507. ICP-AES confirmed the removal of 90-93% of the original copper content in the structures.

Synthesis of COF-300 (dia-c7). 7-fold interpenetrated COF-300 was synthesized following a previously reported procedure (17). A 10 mL glass tube was charged with tetra-(4-anilyl) methane (20.0 mg, 0.052 mmol), terephthaldehyde (12.0 mg, 0.089 mmol), and 1.0 mL of 1,4-dioxane. Then 0.2 mL of aqueous acetic acid (15 M) was added into the solution. The tube was flash frozen in a liquid nitrogen bath, evacuated to vacuum and flame sealed. The fused tube was heated at 120° C. for 72 h, then a yellow solid was produced at the bottom of the tube. The crude product was isolated by centrifugation and Soxhlet extraction in 1,4-dioxane for 24 h, dried at ambient temperature for 12 h, and further dried at 120° C. for 12 h to afford a yellow powder, which was identified as dia-c7 COF-300.

Synthesis of COF-791/COF-791 was synthesized following a previously reported procedure (18). A 10 mL glass tube was charged with 1,3,5-trimethyl-2,4,6-tris(4-formylphenyl)benzene (19.8 mg, 0.05 mmol), 1,2,4,5-tetrakis-(4-aminophenyl)benzene (15.2 mg, 0.03 mmol), p-toluidine (37.0 mg, 0.34 mmol), and 1.0 mL of dioxane. The solution was sonicated for 2 minutes before adding mesitylene (0.5 mL) and TFA (4 μL). The tube was flash frozen at 77 K under liquid N₂, evacuated to an internal pressure of 100 mTorr and flame scaled to a length of 15 cm, approximately. The reaction was heated to 85° C. for 3 days yielding a white solid, COF-791. The solid was isolated by filtration, washed with DMF, 0.1 M NH₄OH in methanol, and methanol. COF-791 was then solvent exchanged with acetone for 2 days. COF-791 was finally activated under dynamic vacuum at room temperature for 1 hour followed by dynamic vacuum at 90° C. for 4 hours to yield 10 mg activated COF-791.

MOF-808. Nanocrystalline powder samples of MOF-808 were prepared using slightly modified published procedures (19). Trimesic acid (23.3 mg, 0.11 mmol) and ZrOCl₂·8H₂O (107.7 mg, 0.33 mmol) were dissolved in DMF/formic acid (7 mL/3 mL) and placed in a 20 mL glass vial, which was heated to 130° C. for two days. A white precipitate was collected by filtration and washed three times with DMF. As-synthesized MOF-808 was then subsequently washed with DMF, water, and acetone. The acetone-exchanged sample was then evacuated at 150° C. for 24 h.

MIL-53(Al). MIL-53(Al) was prepared following an adapted version of a reported synthesis (20). Al(NO₃)₃·9H₂O (1.3 g, 3.46 mmol) and terephthalic acid (288.0 mg, 1.73 mmol) were dissolved in DMF/H₂O (5 mL/5 mL) and placed in a 20 mL glass vial, which was heated to 85° C. for 24 h. The white precipitate, MIL-53(Al), was collected by filtration and washed with H₂O and DMF. The sample was then activated at room temperature for 2 h and at 200° C. for 24 h.

Polyimide films and Polyimide-COF composite films (in situ & blending). 4,4′-Oxydianiline (ODA) (250 mg, 1.25 mmol) and pyromellitic dianhydride (PMDA) (273 mg, 1.25 mmol) were dissolved in n-methyl-2-pyrrolidone (NMP) (2 mL), separately. In the case of in situ Polyimide-COF composite films, COF particles (5-50 mg) were dispersed in NMP (1 mL) using sonication in an ultrasonic bath for 0.5 h, and added to the ODA-NMP solution followed by further sonication for another 0.5 h. In case of pure polyimide film or polyimide-COF composite films prepared by blending, no fillers were added at this moment. The (COF-)ODA-NMP solution was vigorously mixed at room temperature with the PMDA-NMP solution to make (COF-)polyamic acid (PAA) solution. The (COF-)PAA solution was stirred (100 rpm) at 70° C. under nitrogen purging for 12 hours. In the case of the composite films prepared by blending, the PAA solution was vigorously mixed with COF-NMP solutions and stirred (100 rpm) for 2 h. The (COF-)PAA mixture was cast into a glass plate using a doctor blade and dried at 75° C. for 24 hours until the NMP evaporates. The (COF-)PAA films were cured at 100, 200, and 300° C. for 1 h at each temperature, until the films were completely imidized. The films were slowly cooled down to ambient temperature and carefully peeled off to be cut as dog-bone specimens. The films thicknesses were about 40-60 μm.

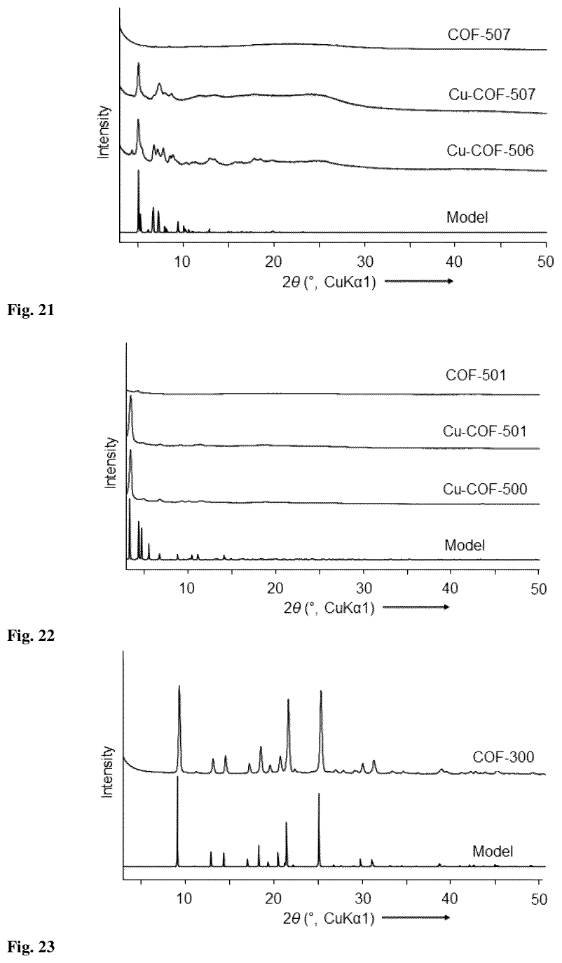

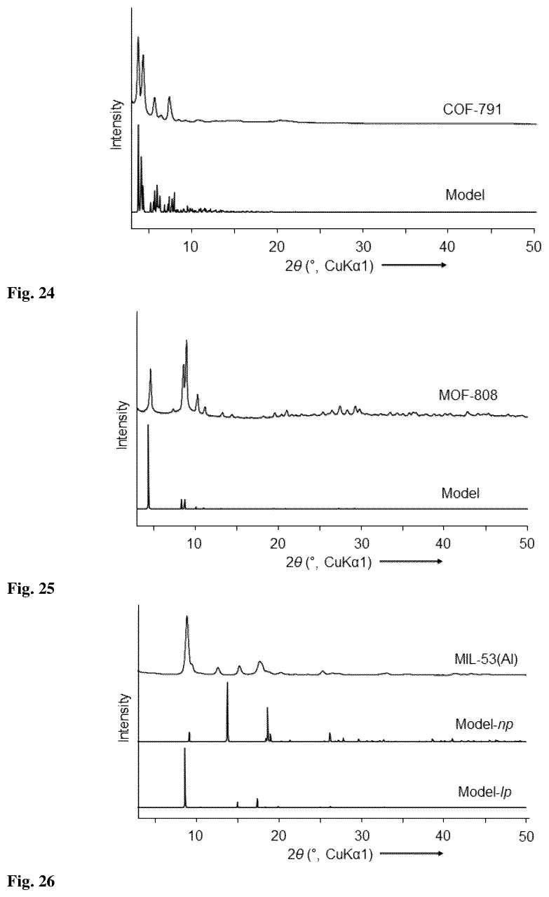

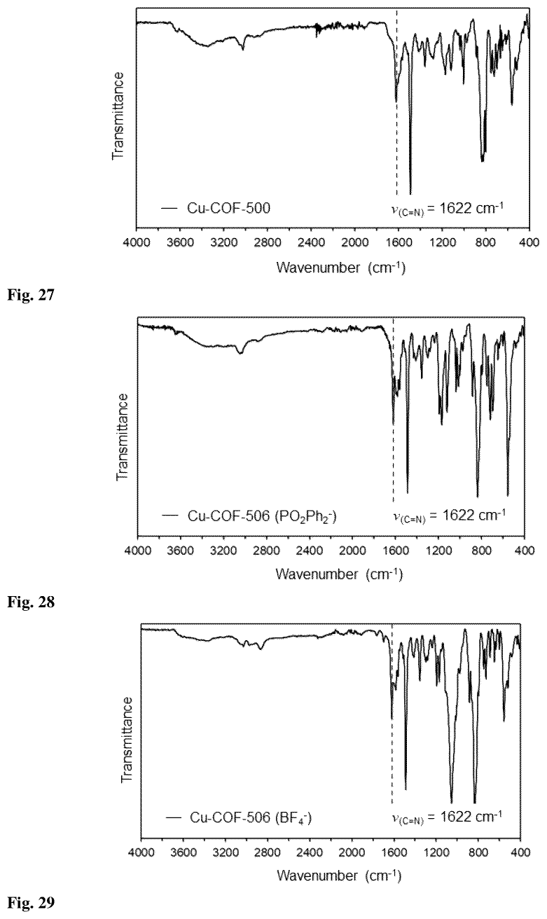

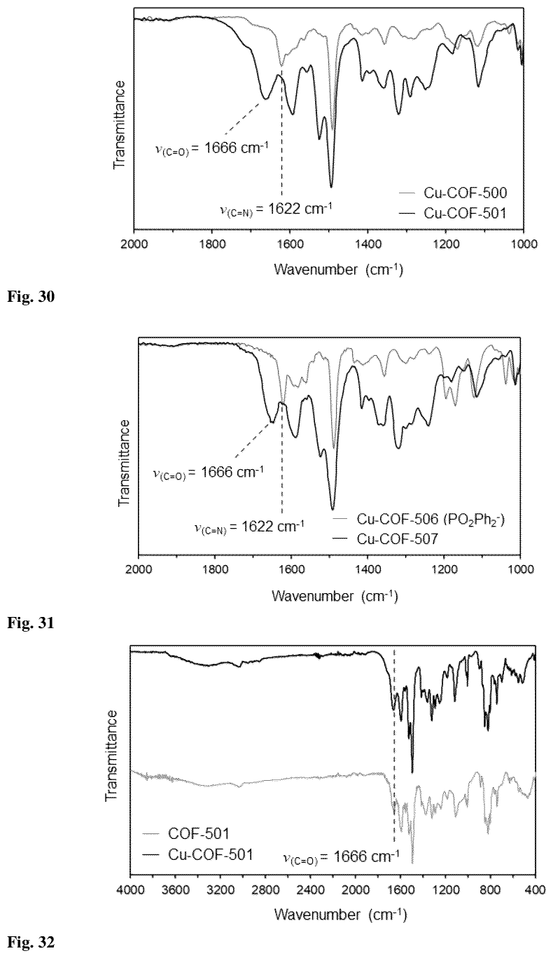

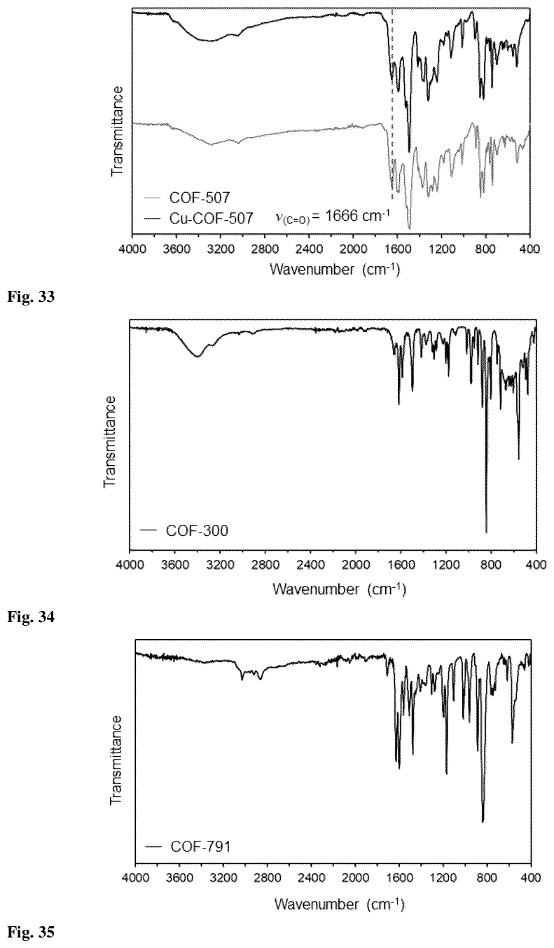

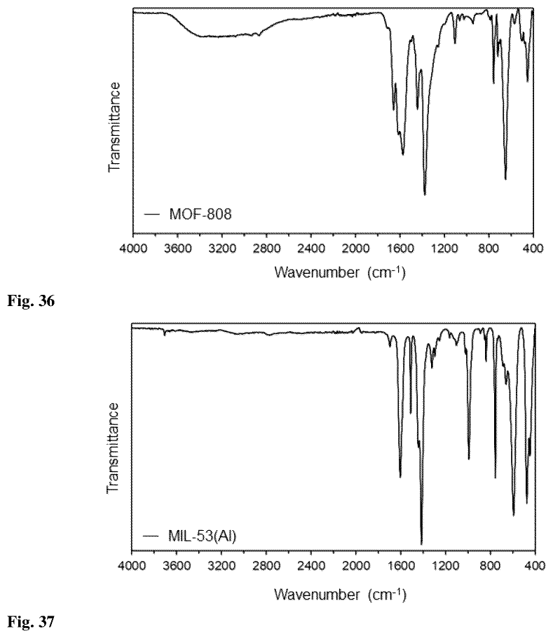

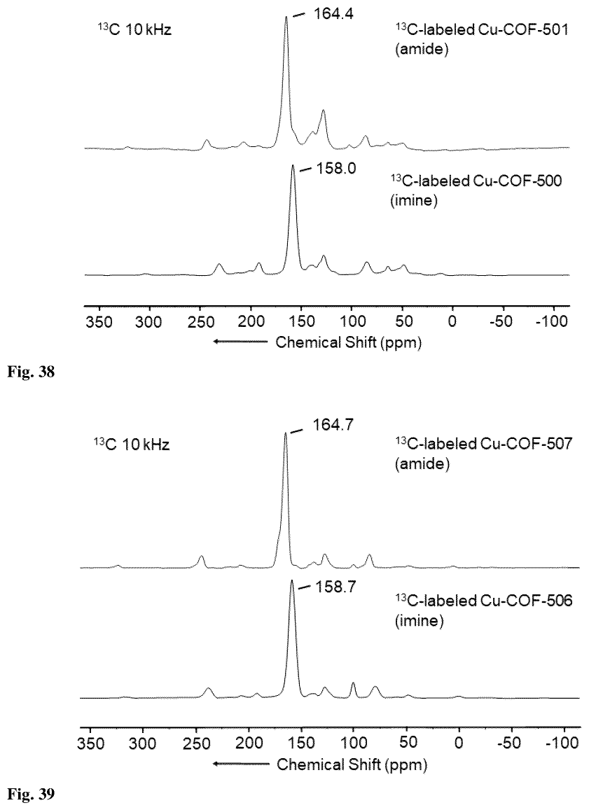

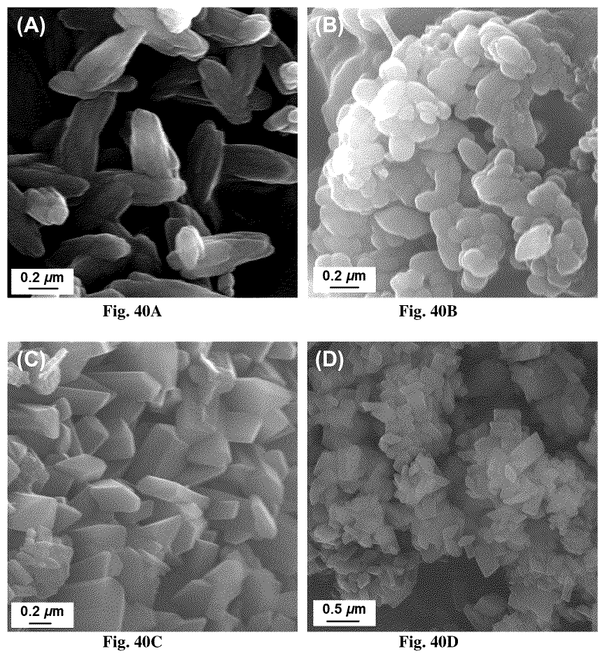

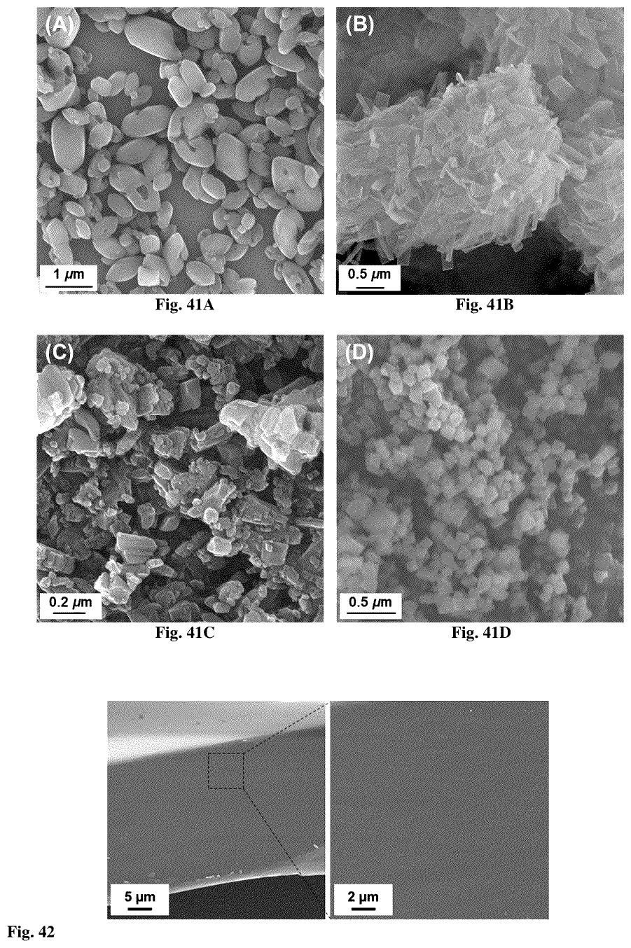

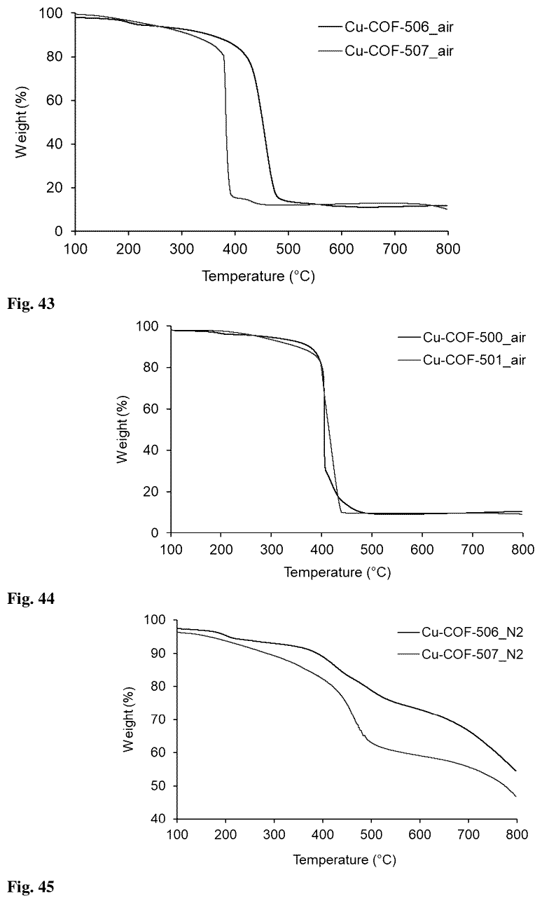

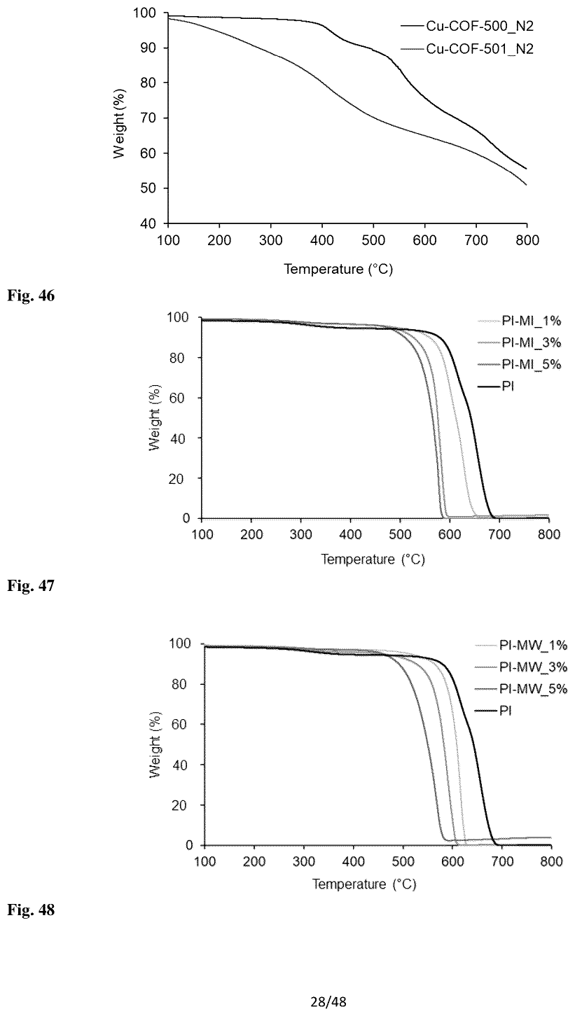

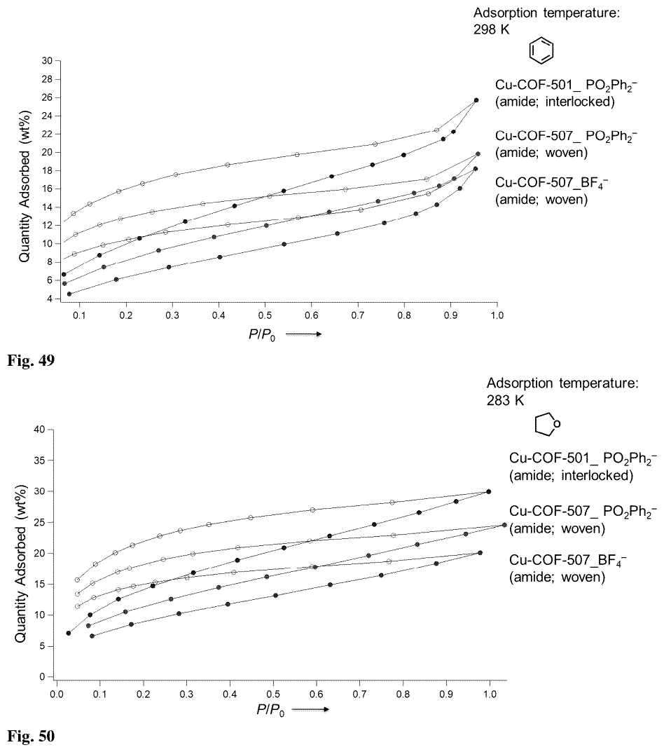

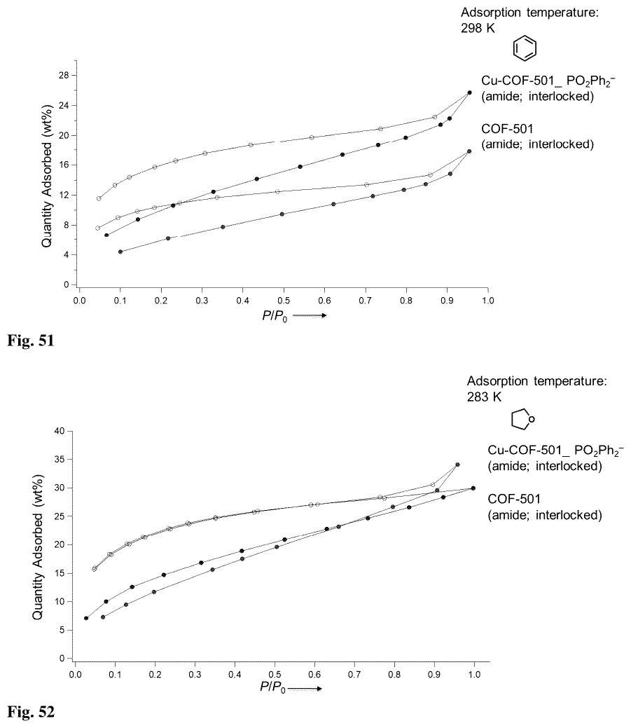

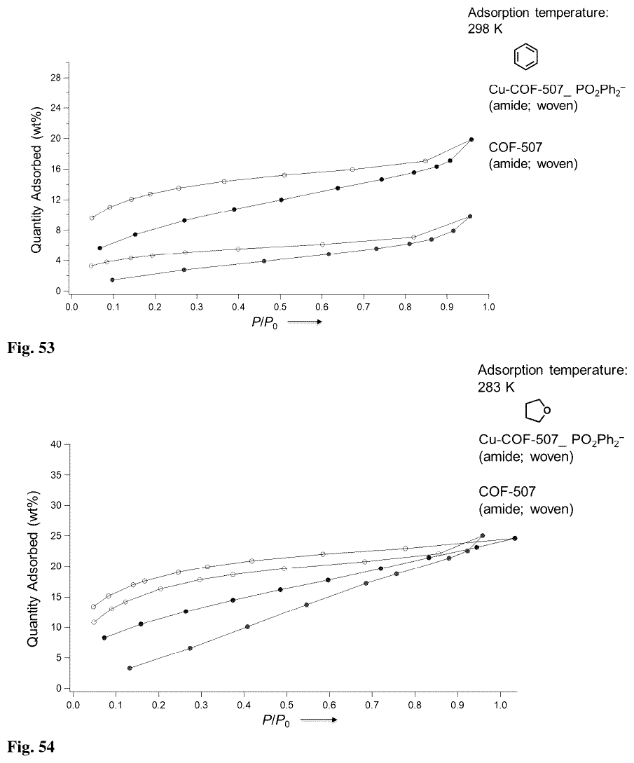

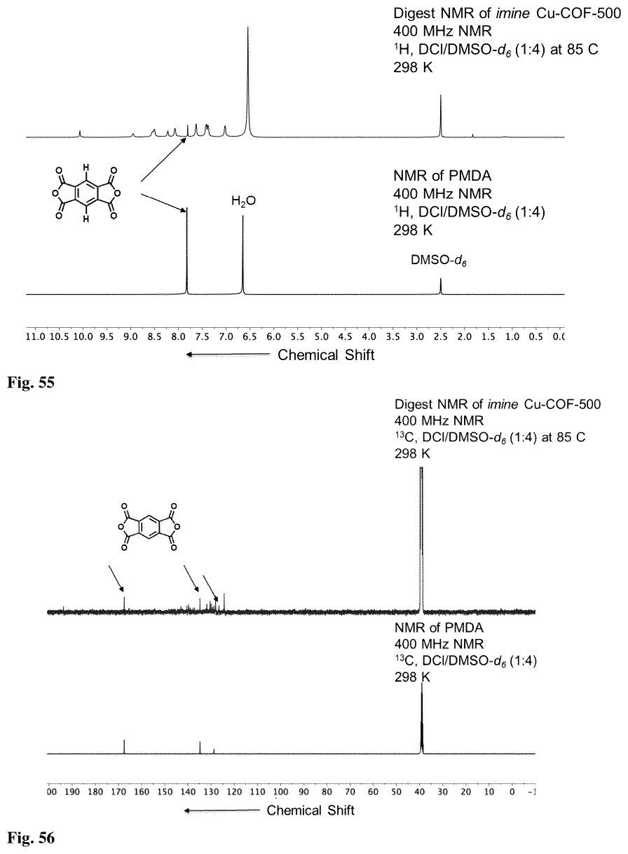

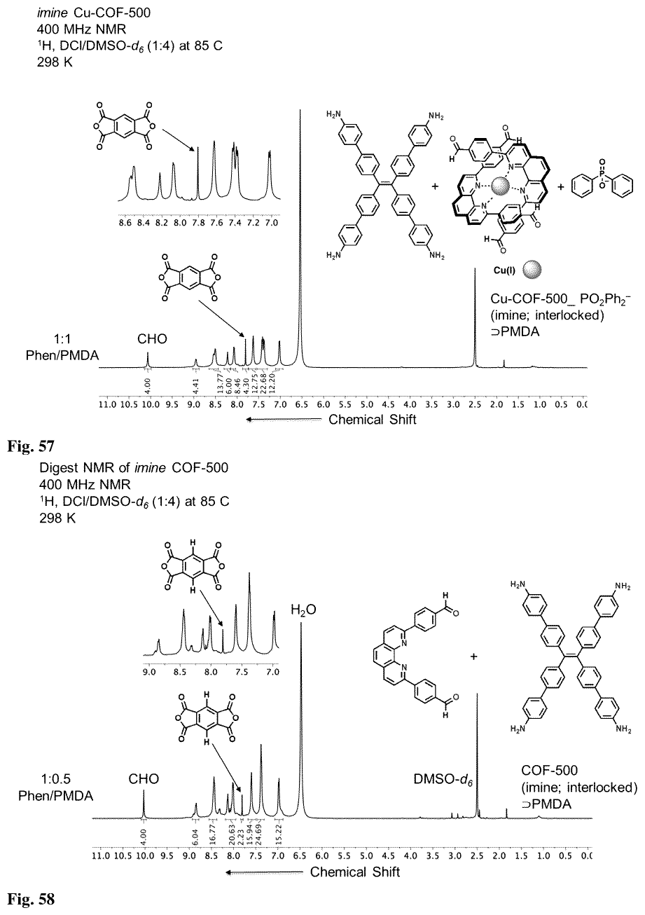

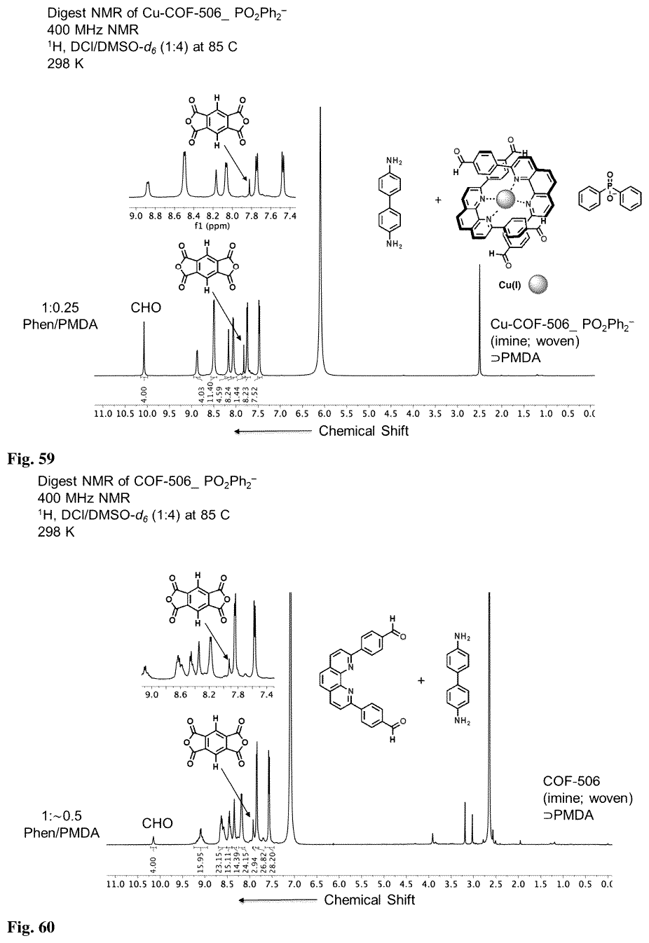

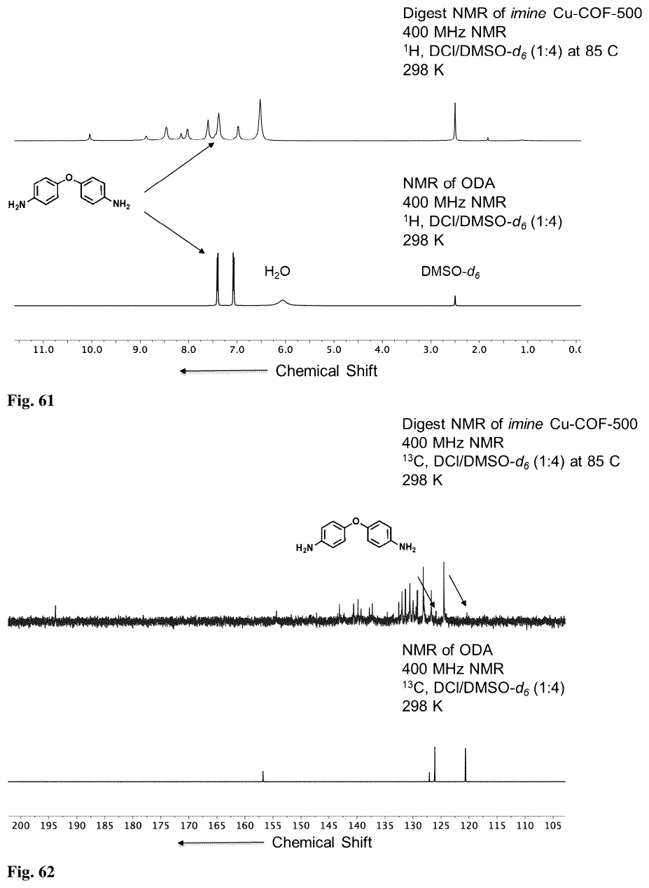

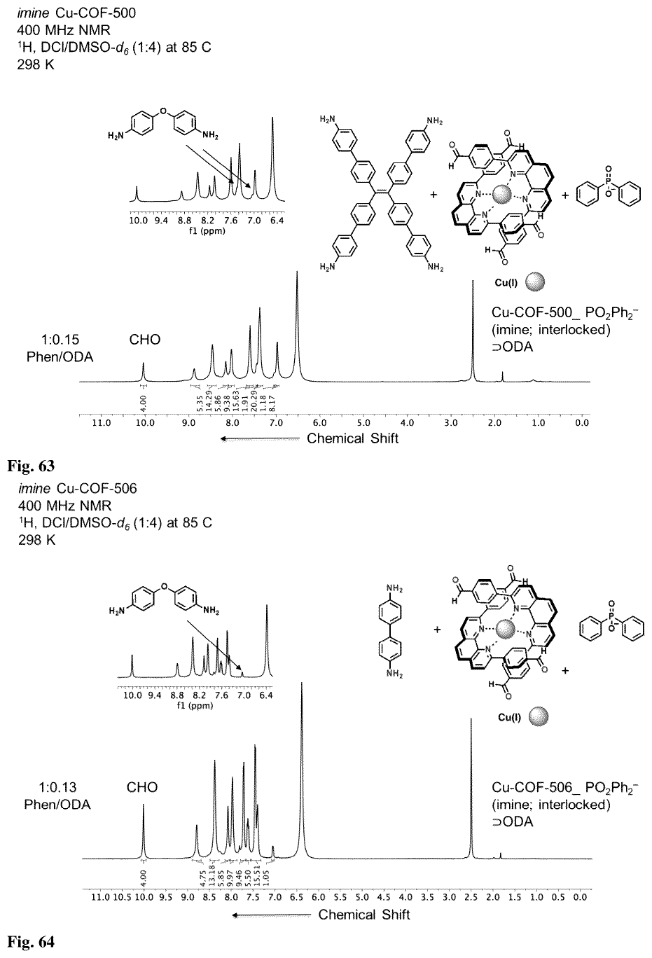

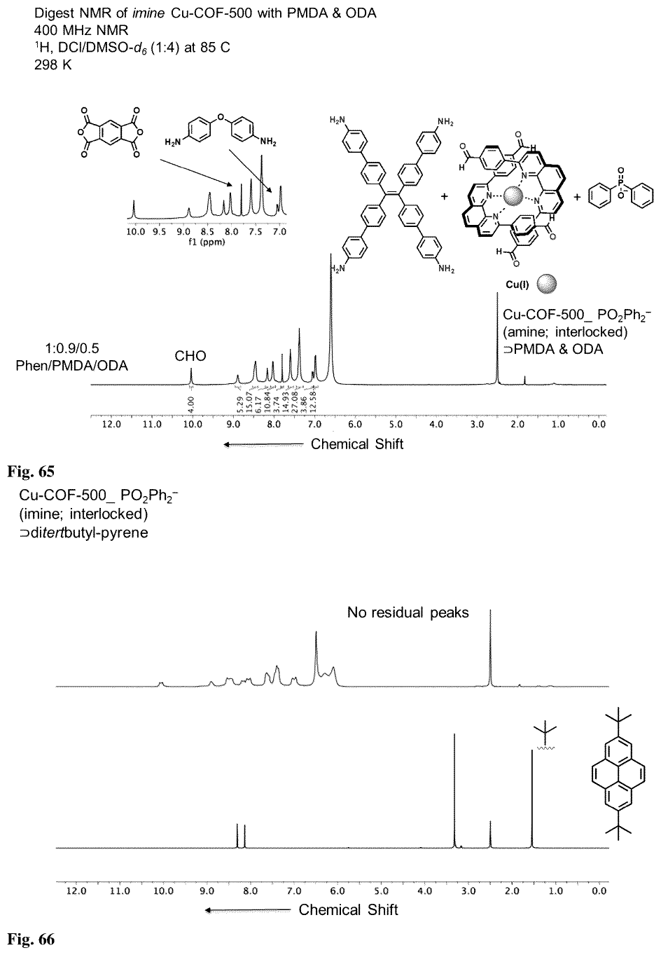

Poly(methyl methacrylate)-COF composites. Methyl methacrylate polymer (PMMA) pellets from Tokyo Chemical Industry CO., LTD. were dissolved in dichloromethane overnight. COF particles were dispersed in toluene using sonication in an ultrasonic bath for 0.5 h, and vigorously mixed with the PMMA solution (150 mg/mL). The solution was cast on a teflon well and dried overnight.
Section S2. Powder X-Ray Diffraction (PXRD): FIGS. 21-26
Section S3. Fourier-transform Infrared Spectroscopy (FTIR): FIGS. 27-37
Section S4. Solid-State NMR: FIGS. 38-39.
Section S5. Scanning Electron Microscopy and Energy Dispersive X-Ray Analysis
(SEM, EDS): FIGS. 40-42
Section S6. Thermogravimetric Analysis (TGA); FIGS. 43-48
Section S7. Vapor Sorption Experiments: FIGS. 49-54
Section S8. Monomer Inclusion Studies (Digest NMR); FIGS. 55-66.

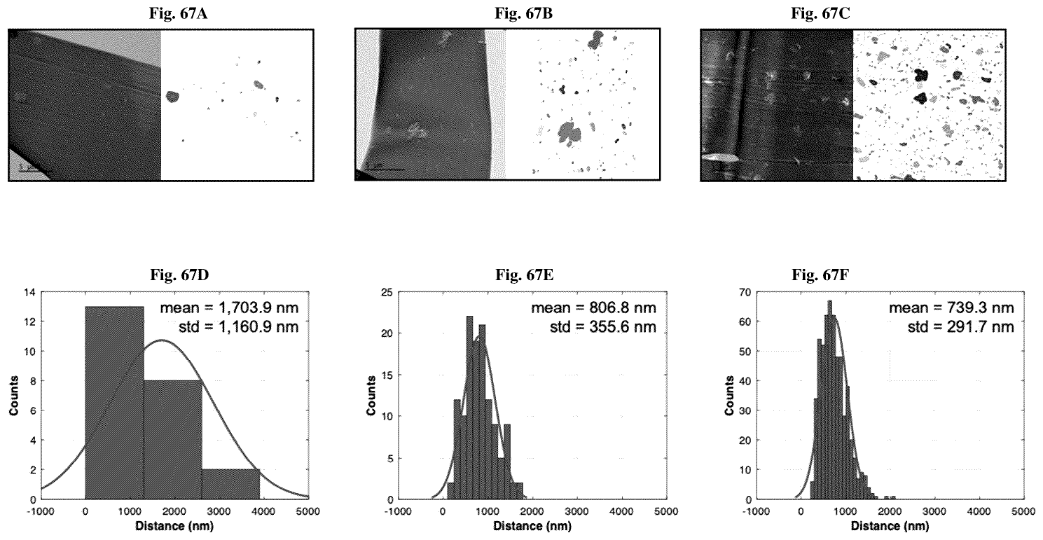

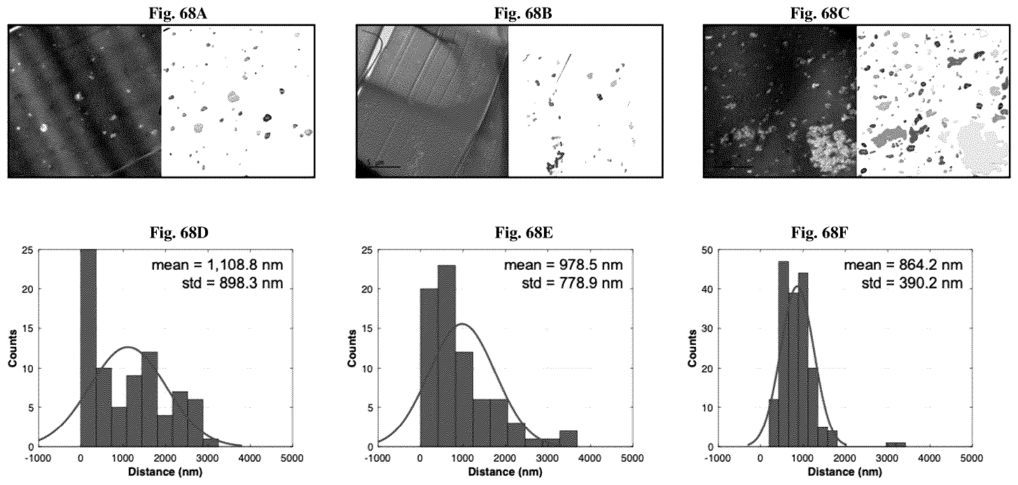

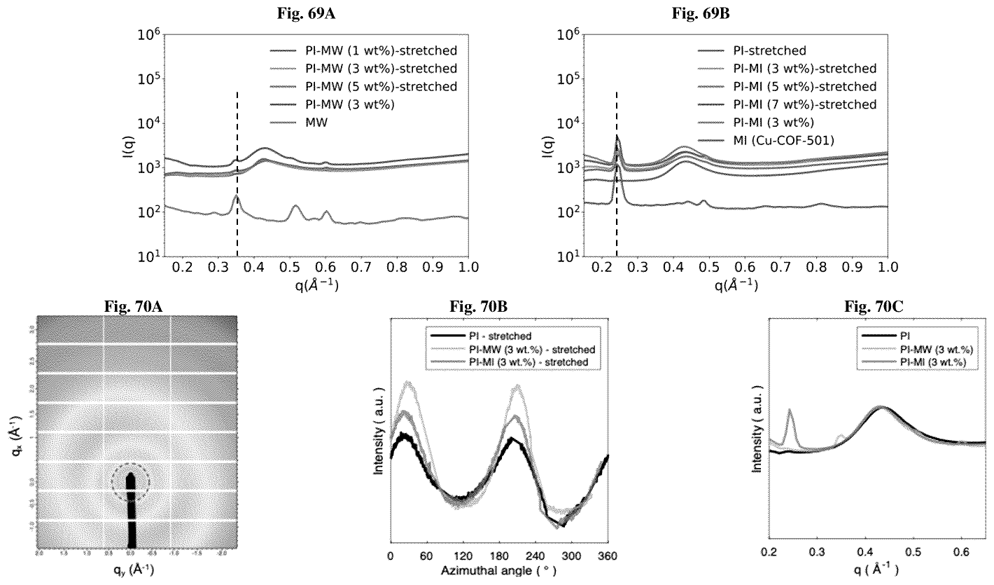

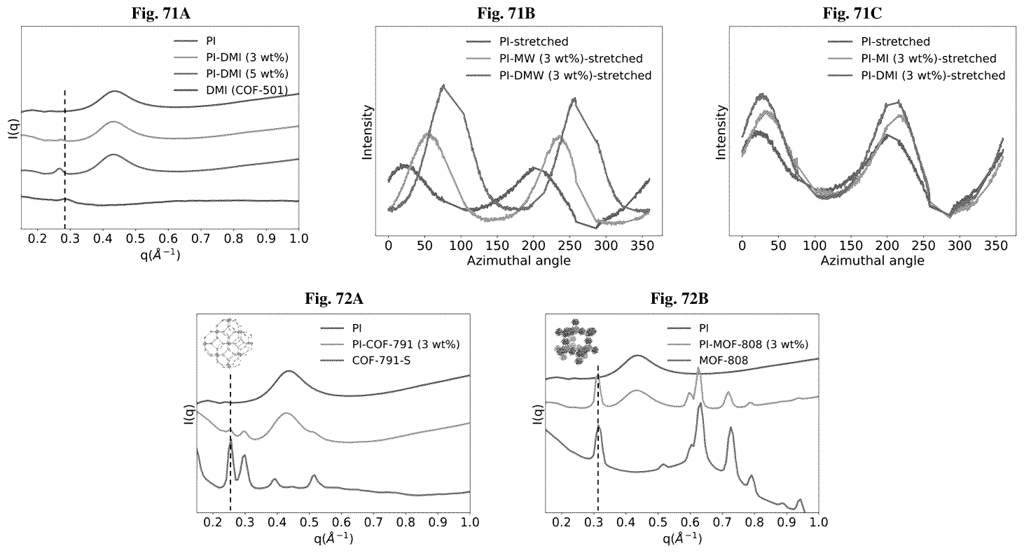

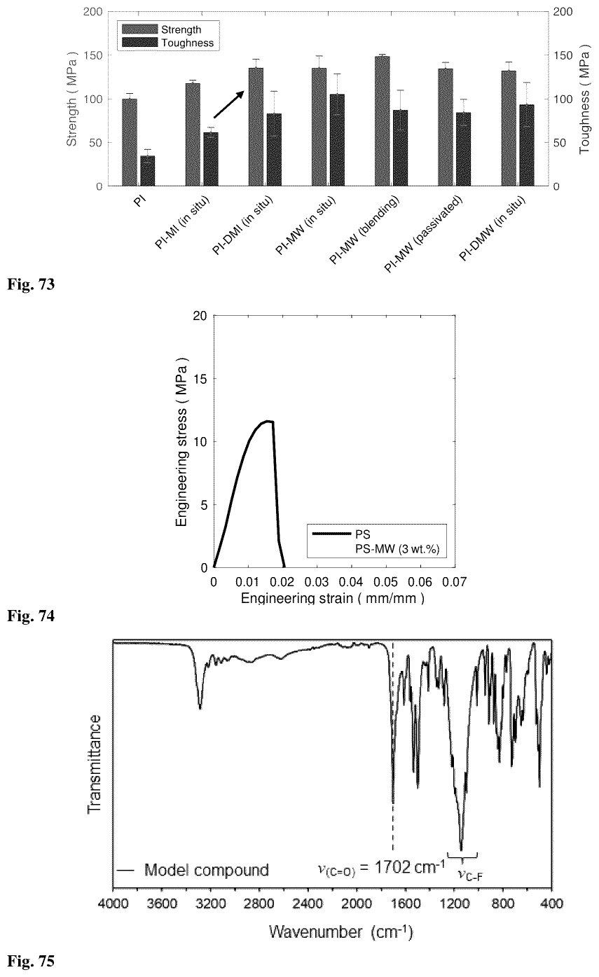

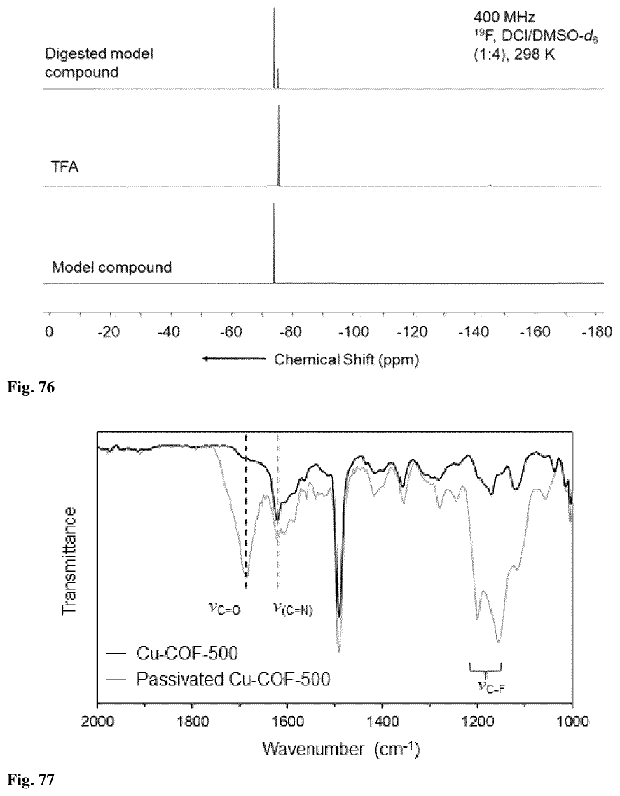

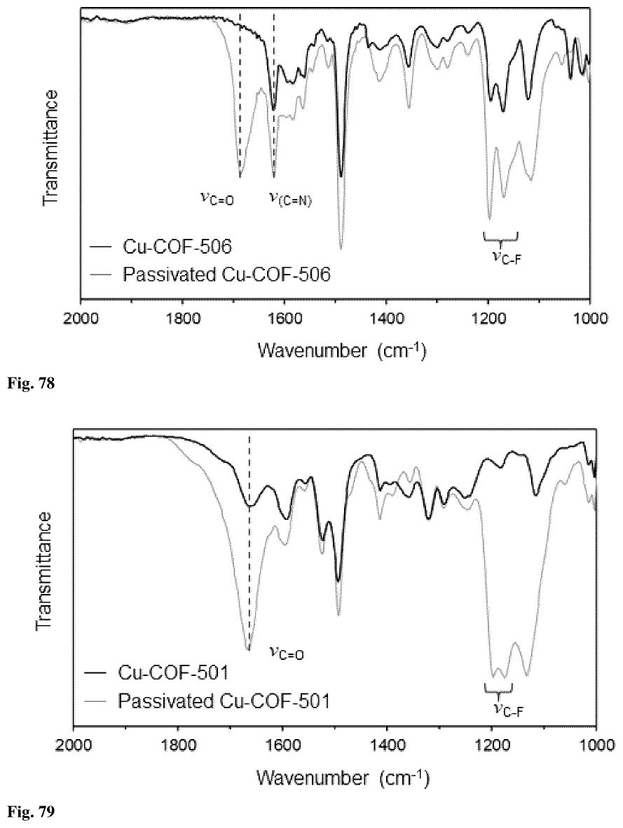

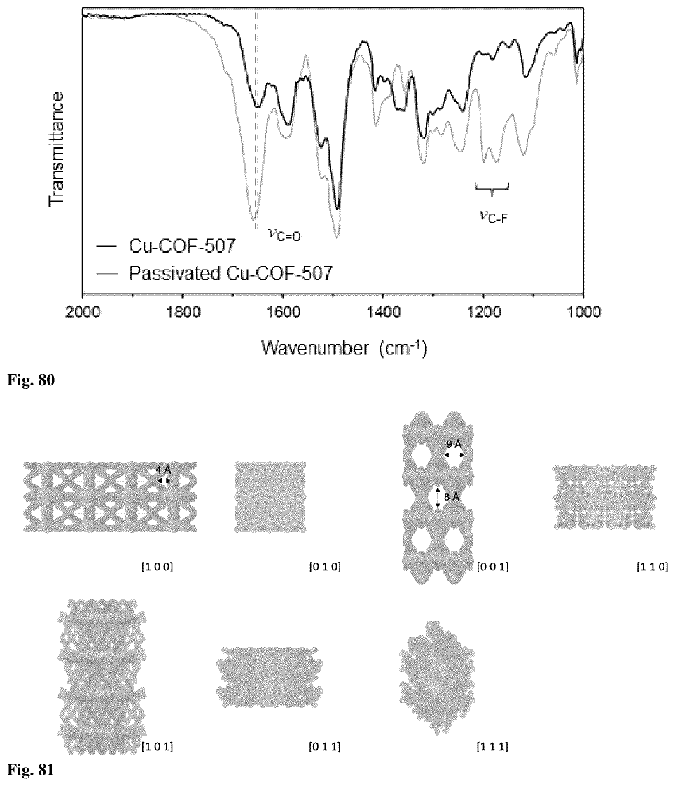

To investigate the potential inclusion of polyimide monomers into the pores of the woven and interlocked COFs, a procedure was designed to mimic the synthetic process of the COF/polyimide composites. First, 100 mg of the monomers (ODA, PMDA) were dissolved in 5 mL of anhydrous DMF. After adding 20-30 mg of COF, the mixture was sonicated for 10 min and subsequently heated to 75° C. for 3 h. The solid COF material was filtered and was with DMF (50 mL), ethanol (100 mL), and chloroform (100 mL) to ensure that molecules on the surface of the crystallites would be washed off. The solvent was removed at 110° C. under vacuum (10-6 bar). The monomers trapped within the COF structure were quantified by digest NMR, in which the framework is broken down into its starting materials using 0.5 mL of DMSO-d₆/DCl (4:1) at 85° C.
Section S9. Transmission Electron Microscopy (TEM): FIGS. 67-68
Section S10. Wide Angle X-Ray Scattering (WAXS): FIGS. 69-72
Section S11. Tensile Tests: FIGS. 73-74
Section S12. Surface Passivation (FTIR and Digest NMR): FIGS. 75-80
   Model System: Reaction of 4,4′-Oxydianiline (ODA) with Trifluoroacetic Acid Anhydride (TFAA)

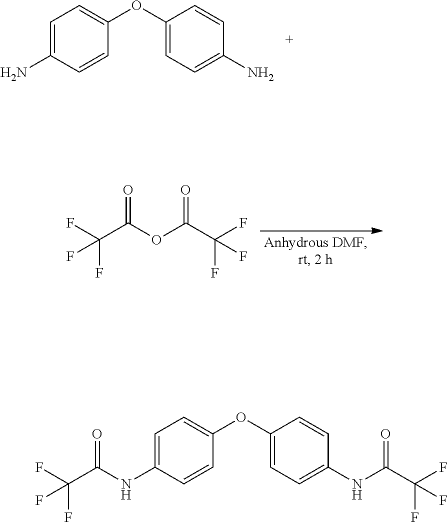 [SMILES: Nc1ccc(Oc2ccc(N)cc2)cc1 ; O=C(OC(=O)C(F)(F)F)C(F)(F)F ; O=C(Nc1ccc(Oc2ccc(NC(=O)C(F)(F)F)cc2)cc1)C(F)(F)F]

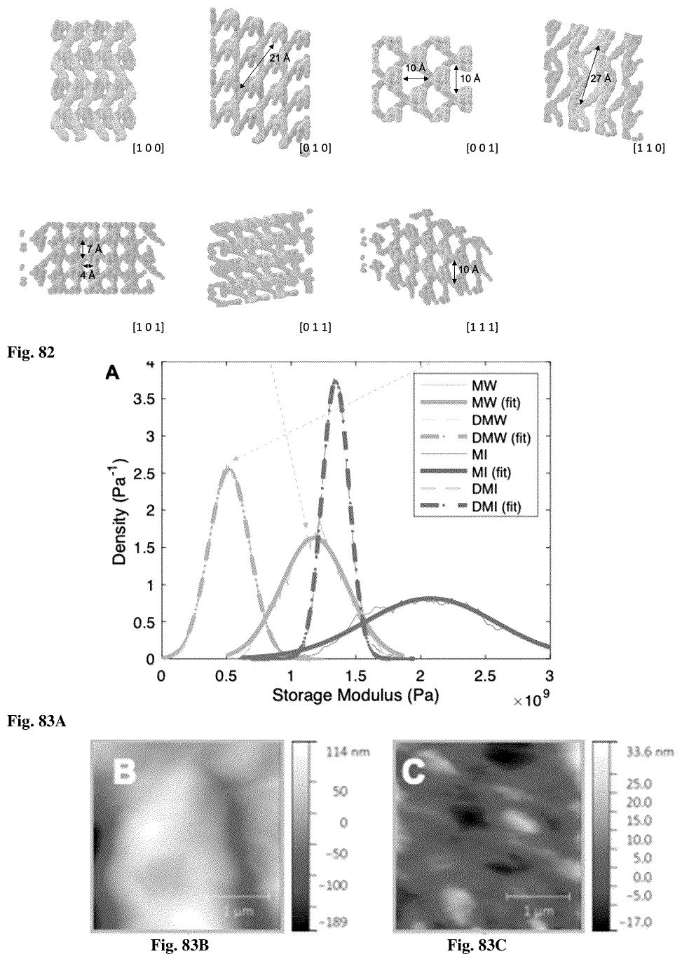

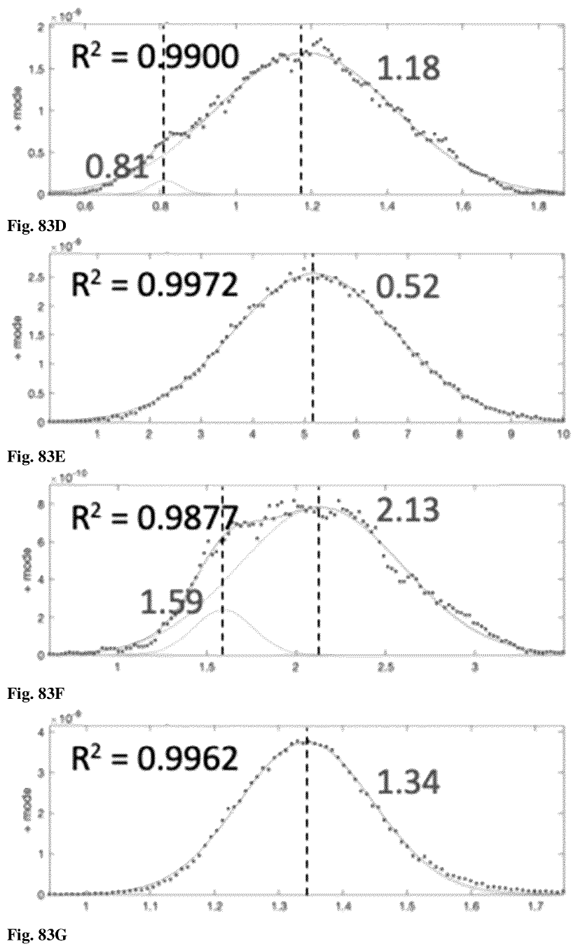

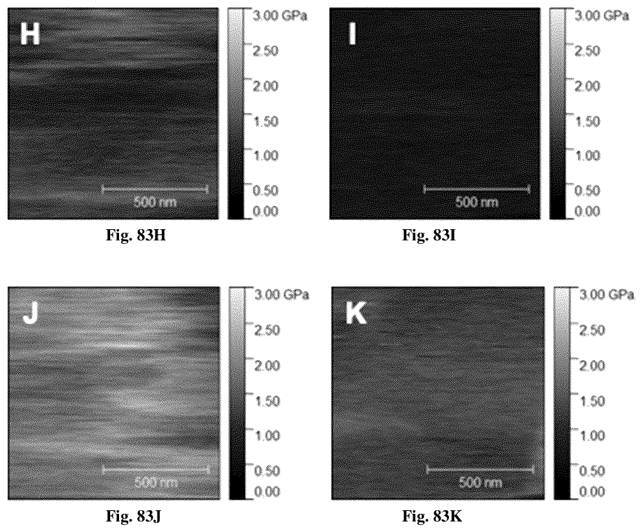

Section S13. Topology of COFs: FIGS. 81-82
Section S14. Nano DMA: FIGS. 83A-K

TABLE S1
Mechanical properties of COF-polymer nanocomposites measured
by engineering stress-strain curves from tensile tests.

| | Strength | Toughness | Fracture Strain |
|---|---|---|---|
| | (=σₘₐₓ) | (=ƒ σde) | (=ϵ_{f}) |
| Samples | (MPa) | (MPa) | (mm/mm) |
| PI | 100.0(±6.2) | 34.6(±7.6) | 0.4420 |
| | | | (±0.0677) |
| PI-MW (1 wt. %) | 130.2(±9.2) | 97.6(±21.5) | 0.9743 |
| | | | (±0.1689) |
| PI-MW (3 wt. %) | 135.1(±13.9) | 105.3(±23.3) | 0.9965 |
| | | | (±0.1289) |
| PI-MW (5 wt. %) | 133.7(±9.8) | 79.0(±27.3) | 0.7441 |
| | | | (±0.2050) |
| PI-MW (3 wt. %) blending | 148.4(±2.4) | 87.2(±22.7) | 0.7456 |
| | | | (±0.1860) |
| PI-MW (3 wt. %) passivated | 134.5(±7.1) | 84.5(±15.0) | 0.8038 |
| | | | (±0.1062) |
| PI-DMW (3 wt. %) | 132.1(±9.9) | 93.5(±25.1) | 0.9022 |
| | | | (±0.1901) |
| PMMA | 32.4(±0.7) | 2.6(±0.5) | 0.1303 |
| | | | (±0.0196) |
| PMMA-MW (3 wt. %) | 33.4(±0.9) | 5.6(±1.4) | 0.2216 |
| | | | (±0.0383) |
| PS | 11.4(±2.3) | 0.10(±0.02) | 0.0178 |
| | | | (±0.0016) |
| PS-MW (3 wt. %) | 11.9(±1.6) | 0.29(±0.18) | 0.0339 |
| | | | (±0.0132) |
| PI-MI (1 wt. %) | 111.1(±4.3) | 55.4(±5.4) | 0.6342 |
| | | | (±0.0521) |
| PI-MI (3 wt. %) | 117.8(±3.6) | 61.8(±5.7) | 0.6690 |
| | | | (±0.0518) |
| PI-MI (5 wt. %) | 130.6(±13.4) | 72.1(±28.5) | 0.6950 |
| | | | (±0.2149) |
| PI-MI (3 wt. %) blending | 120.0(±10.5) | 53.2(±16.9) | 0.5587 |
| | | | (±0.1293) |
| PI-MI (3 wt. %) passivated | 112.6(±6.8) | 52.6(±7.5) | 0.5986 |
| | | | (±0.0637) |
| PI-DMI (3 wt. %) | 135.4(±10.0) | 83.2(±25.7) | 0.7795 |
| | | | (±0.1865) |
| PI-COF-300 (3 wt. %) | 101.4(±5.5) | 27.3(±7.1) | 0.3509 |
| | | | (±0.0691) |
| PI-COF-791 (3 wt. %) | 108.5(±2.8) | 43.8(±4.9) | 0.5206 |
| | | | (±0.0457) |
| PI-MIL-53 (3 wt. %) | 111.5(±6.5) | 24.8(±7.0) | 0.2945 |
| | | | (±0.0612) |
| PI-MOF-808 (3 wt. %) | 90.0(±8.5) | 18.9(±6.7) | 0.2799(±0.077) |

1. A composite composition comprising amide-linked, crystalline, woven and interlocked covalent organic frameworks (COFs) and a polymer, wherein the COFs are mechanically-bonded into matrices of the polymer, wherein chains of the polymer are threaded through the COFs forming polymer-COF junctions.

2. A composition of claim 1, wherein COFs are in the form of particles, in sizes of about 50-500 nm.

3. A composition of claim 1, wherein COFs are in the form of particles, in sizes of about 100-300 nm.

4. A composition of claim 1, comprising from about 0.1 to about 5 weight percent (wt %) of the COFs.

5. A composition of claim 1, comprising from about 1 to about 5 weight percent (wt %) of the COFs.

6. A composition of claim 1, comprising a homogenous distribution of the COFs within the polymer, with no phase separation.

7. A composition of claim 1, providing an increase in elastic modulus and toughness of the COF-polymer composites by more than 30%, compared with the polymer.

8. A composition of claim 1, wherein the polymer is amorphous.

9. A composition of claim 1, wherein the polymer is liquid crystalline.

10. A composition of claim 1, wherein the polymer is selected from a polyimide, polyester, polyamide, and polyamine.

11. A composition of claim 1, wherein the polymer is polyimide.

12. A composition of claim 1, wherein the polymer is polymethyl methacrylate (PMMA).

13. A composition of claim 1, wherein the polymer is poly (4,4′-oxydipehnylene-pyromellitimide).

14. A composition of claim 1, wherein the COF is selected from COF-500/COF-501 and COF-506/COF-507.

15. A composition of claim 1, wherein the COFs comprise covalently linked organic building units that form one-dimensional organic threads, which are interlaced to generate a 3D woven structure in the form of crystals hundreds of nanometers in size.

16. A composition of claim 1, wherein the COFs comprise multiple repeating unit cells that generate a porous environment mimicing the polymer matrix in its chemical structure, facilitating polymer/COF interactions.

17. A composition of claim 1, wherein unit cells of the COFs have dimensions comparable to the tube diameter of the polymer reptation, facilitating the polymer chains to thread through the COFs.

18. A composition of claim 1, wherein the COFs are penetrated by chains of the polymer, thereby chemically decorating the surface, which enhances the chemical compatibility with the polymer matrix.

19. A composition of claim 1, wherein dangling polymer chains on the surface of the COF nanocrystals form interfaces to bridge between the interwoven polymer chains and the matrix to form polymer-COF junctions.

20. A method of making a composite composition of claim 1 comprising combining the COFs and the polymer under conditions to form the composite composition, or
a method of enhancing a mechanical property (e.g. toughness or elasticity) of a polymer by combining the polymer with COFs to form a composite composition of claim 1.
